(19) United States
(12) Patent Application Publication
(10) Pub. No.: US 2026/0189792 A1
(43) Pub. Date: Jul. 2, 2026

(54) SYSTEM

(71) Applicant: CANON KABUSHIKI KAISHA, Tokyo (JP)

(72) Inventor: ASUKA MATSUOKA, Kanagawa (JP)

(21) Appl. No.: 19/543,193

(22) Filed: Feb. 18, 2026

Related U.S. Application Data
(63) Continuation of application No. PCT/JP2024/031119, filed on Aug. 30, 2024.

(30) Foreign Application Priority Data
Sep. 7, 2023 (JP) 2023-145575
Aug. 7, 2024 (JP) 2024-131210

(51) Int. Cl. H04N 23/695; G06V 10/74; G06V 10/75; H04N 23/61; H04N 23/90

(52) U.S. Cl. CPC H04N 23/695; G06V 10/761; H04N 23/61; H04N 23/90; G06V 10/751

(57) ABSTRACT

A system which includes a first and second image capture apparatuses, and a first and second control apparatuses which control the second image capture apparatus to track a predetermined subject based on one of a first image of the first image capture apparatus and a second image of the second image capture apparatus. The first control apparatus controls the second image capture apparatus based on first feature information of the predetermined subject included in the first image. The second control apparatus controls the second image capture apparatus based on the second feature information of the subject included in the second image. The system switches between a first state in which the first control apparatus controls the second image capture apparatus and a second state in which the second control apparatus controls the second image capture apparatus.

### CROSS-REFERENCE TO RELATED APPLICATIONS

This application is a Continuation of International Patent Application No. PCT/JP2024/031119, filed Aug. 30, 2024, which claims the benefit of Japanese Patent Application Nos. 2023-145575, filed Sep. 7, 2023 and 2024-131210, filed Aug. 7, 2024, all of which are hereby incorporated by reference herein in their entirety.

### BACKGROUND

### Field of the Technology

The present disclosure relates to a system that tracks a specific subject using a plurality of image capture apparatuses having different image capture positions or image capture directions.

### Description of the Related Art

There is a technique of tracking a specific subject using an image capture apparatus capable of automatically controlling pan/tilt/zoom (PTZ) from a remote site. In such automatic tracking control, PTZ is automatically controlled such that the tracking target subject is arranged at a desired position in an image capture angle of view.

Japanese Patent Laid-Open No. 2017-204795 describes a technique for tracking a specific subject by coordinating an image capture apparatus with a fixed wide-angle field of view (fixed-angle camera) and an image capture apparatus with PTZ functionality (PTZ camera). Japanese Patent Laid-Open No. 2017-204795, even when the tracking target moves outside the field of view of the fixed-angle camera and can no longer be captured, enables the PTZ camera to capture the tracking target by predicting the movement of the tracking target.

Also, Japanese Patent No. 3814779 describes a technique of, when a tracking target subject moves near the boundary of the image capture range of a first image capture apparatus, transmitting the template data of the tracking target subject generated by the first image capture apparatus to a second image capture apparatus and making the second image capture apparatus take over the tracking target.

However, since the tracking target subject is discriminated by template matching in Japanese Patent Laid-Open No. 2017-204795 and Japanese Patent No. 3814779, when tracking the specific subject using a plurality of image capture apparatuses, the plurality of image capture apparatuses need to be arranged such that these have close image capture positions or image capture directions. For this reason, when image capture positions or image capture directions of the plurality of image capture apparatuses are arranged far apart, it is difficult to track the specific subject by the plurality of image capture apparatuses.

### SUMMARY

The present disclosure has been made in consideration of the aforementioned problems, and provides technical advantages in a system capable of tracking a specific subject using a plurality of image capture apparatuses having different image capture positions or image capture directions.

In order to solve the aforementioned problems, the present disclosure provides a system which includes a first image capture apparatus and a second image capture apparatus, which have different image capture directions, and a first control apparatus and a second control apparatus, which control the second image capture apparatus to track a predetermined subject based on a first image captured by the first image capture apparatus or a second image captured by the second image capture apparatus,
wherein
the first control apparatus comprises:
a first generation unit that generates first feature information of the predetermined subject included in the first image; and
a first control unit that controls the second image capture apparatus to track the predetermined subject based on the first feature information, and
the second control apparatus comprises:
a second generation unit that generates second feature information of a subject included in the second image;
a comparison unit that compares the first feature information generated by the first control apparatus with the second feature information generated by the second generation unit; and
a second control unit that controls the second image capture apparatus to track the predetermined subject based on the second feature information,
wherein the first feature information and the second feature information are information capable of specifying the same subject when the same subject is captured by a plurality of image capture apparatuses having different image capture directions, and
wherein based on a comparison result by the comparison unit, the system is configured to switch between a first state in which the first control apparatus controls the second image capture apparatus to track the predetermined subject based on the first feature information and a second state in which the second control apparatus controls the second image capture apparatus to track the predetermined subject based on the second feature information.

Features of the present disclosure will become apparent from the following description of embodiments with reference to the attached drawings.

### BRIEF DESCRIPTION OF THE DRAWINGS

FIG. 1 is a view exemplifying a system configuration according to the first embodiment.

FIGS. 2A and 2B are views exemplifying the hardware configurations of apparatuses that constitute the system according to the first embodiment.

FIG. 3 is a view exemplifying the functional configurations of the apparatuses that constitute the system according to the first embodiment.

FIGS. 4A to 4D are flowcharts exemplifying the basic operations of the apparatuses that constitute the system according to the first embodiment.

FIGS. 5A and 5B are views illustrating a coordinate transformation method of a captured image according to the first embodiment.

FIGS. 6A and 6B are views illustrating a subject detection method and a coordinate transformation method according to the first embodiment.

FIG. 7 is a view illustrating pan control according to the first embodiment.

FIG. 8 is a view illustrating tilt control according to the first embodiment.

FIGS. 9A to 9C are flowcharts exemplifying control processing according to the first embodiment.

FIGS. 10A to 10F are views illustrating a tracking target subject decision method according to the first embodiment.

FIG. 11 is a view exemplifying the functional configurations of apparatuses that constitute a system according to the second embodiment.

FIG. 12 is a flowchart exemplifying control processing according to the second embodiment.

FIG. 13 is a flowchart exemplifying control processing according to the second embodiment.

FIG. 14 is a view exemplifying a system configuration according to the third embodiment.

FIG. 15 is a view exemplifying roles and contents that can be set in an image capture apparatus according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <System Configuration>

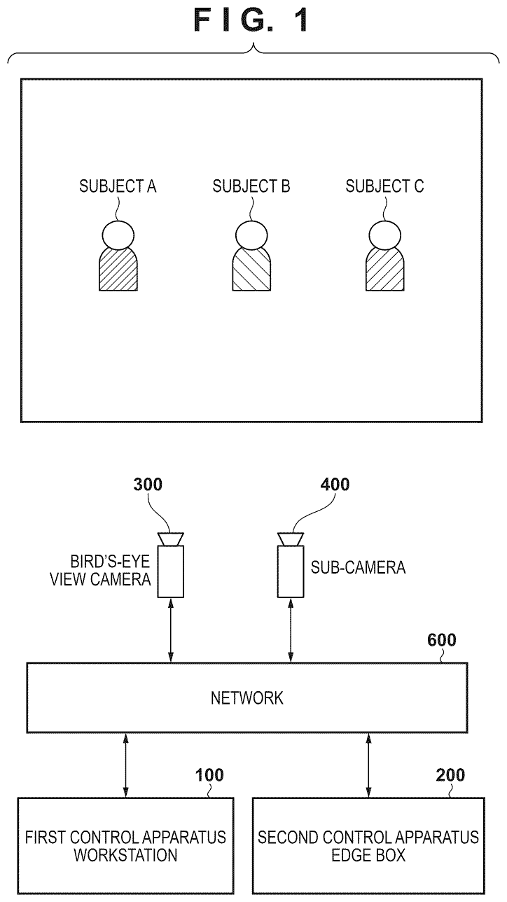

A system configuration according to the first embodiment will be described first with reference to FIG. 1.

The system according to the present embodiment includes a first control apparatus 100, a second control apparatus 200, a first image capture apparatus 300, and a second image capture apparatus 400. The system according to the present embodiment controls the second image capture apparatus 400 by one of the first control apparatus 100 and the second control apparatus 200 to track a specific subject. In the present embodiment, the specific subject is, for example, a person but may be an animal or an object.

The first control apparatus 100 detects a tracking target subject from an overview (hereinafter a bird's eye view) image captured by the first image capture apparatus 300, and controls the second image capture apparatus 400 based on the detection result. The first control apparatus 100 is also called a workstation. The tracking target subject is set, for example, by a user operation or automatically.

The second control apparatus 200 controls the second image capture apparatus 400 based on a tracking target subject recognition result by a bird's eye view image captured by the first image capture apparatus 300 and a tracking target subject recognition result by a sub-image captured by the second image capture apparatus 400. The second control apparatus 200 is also called an edge box.

The first image capture apparatus 300 has an image capture angle of view set to a wide angle, and can capture a bird's eye view image including all of a subject A, a subject B, and a subject C. The first image capture apparatus 300 is also called a bird's eye view camera. The second image capture apparatus 400 has a variable image capture angle of view, and can capture at least one of the subject A, the subject B, and the subject C. The second image capture apparatus 400 is called a sub-camera. The first image capture apparatus 300 and the second image capture apparatus 400 are arranged at positions apart from each other such that these have different image capture positions and/or image capture directions.

The first control apparatus 100, the second control apparatus 200, the first image capture apparatus 300, and the second image capture apparatus 400 are connected so as to be able to communicate therewith via a network 600 such as a local area network (LAN). Note that in the present embodiment, an example in which the first control apparatus 100, the second control apparatus 200, the first image capture apparatus 300, and the second image capture apparatus 400 are connected via the network 600 will be described, but these may be connected by a connection cable (not shown). Also, in the present embodiment, an example in which one second image capture apparatus 400 is provided will be described, but two or more second image capture apparatuses 400 may be provided. When there are a plurality of second image capture apparatuses 400, the second control apparatus 200 is provided in consideration of each second image capture apparatus 400.

The basic function of the system according to the present embodiment will be described next.

The first image capture apparatus 300 captures a bird's eye view image, and transmits the bird's eye view image to the first control apparatus 100 via the network 600.

The second image capture apparatus 400 captures a sub-image including a tracking target subject (tracking subject), and transmits the sub-image to the second control apparatus 200 via the network 600. Note that the second image capture apparatus 400 has a PTZ function. The PTZ function is a function capable of controlling pan, tilt, and zoom of the image capture apparatus. PTZ is an acronym for Panoramic, Tilt, and Zoom. Pan (Panoramic) is movement of the optical axis of the image capture apparatus in the horizontal direction. Tilt is movement of the optical axis of the image capture apparatus in the vertical direction. Zoom indicates zoom-up (telephoto) and zoom-out (wide angle). Pan and tilt are functions of changing the image capture direction of the image capture apparatus. Zoom is a function of changing the image capture range (image capture angle of view) of the image capture apparatus.

The first control apparatus 100 decides a tracking subject from a subject detected from the bird's-eye view image received from the first image capture apparatus 300, and calculates first feature information of the tracking subject from the bird's-eye view image. The first control apparatus controls the second image capture apparatus 400 to change the image capture direction and the image capture range of the second image capture apparatus 400 to the image capture direction and the image capture range of the tracking subject based on the first feature information of the tracking subject.

After the image capture direction and the image capture range of the second image capture apparatus 400 are changed to the image capture direction and the image capture range of the tracking subject, the first control apparatus 100 transmits the first feature information of the tracking subject calculated from the bird's-eye view image to the second control apparatus 200.

The second control apparatus 200 detects a subject from the sub-image received from the second image capture apparatus 400, and calculates second feature information of the detected subject. The second control apparatus 200 compares the second feature information of the subject detected from the sub-image with the first feature information of the tracking subject received from the first control apparatus 100.

When the similarity between the first feature information of the tracking subject and the second feature information of the subject detected from the sub-image is low, the first control apparatus 100 controls the second image capture apparatus 400 to change the image capture direction and the image capture range of the second image capture apparatus 400 to the image capture direction and the image capture range of the tracking subject based on the first feature information of the tracking subject.

When the similarity between the first feature information of the tracking subject and the second feature information of the subject detected from the sub-image is high, the second control apparatus 200 controls the second image capture apparatus 400 to change the image capture direction and the image capture range of the second image capture apparatus 400 to the image capture direction and the image capture range of the tracking subject based on the second feature information of the subject detected from the sub-image having a high similarity to the first feature information of the tracking subject.

The feature information is information capable of specifying that the subject is the same subject in a case where the same subject is captured by a plurality of image capture apparatuses having different image capture positions and/or image capture directions. The feature information is an inference result output by performing image recognition in inference processing using a learned model, to which a plurality of images obtained by capturing the same subject by the plurality of image capture apparatuses having different image capture positions and/or image capture directions are input. When an inference result indicating that the subject is the same subject is obtained, it can be specified that subjects included in the plurality of images captured by the plurality of image capture apparatuses having different image capture positions and/or image capture directions are the same subjects.

The first control apparatus 100 will be referred to as a workstation (WS), the second control apparatus 200 as an edge box (EB), the first image capture apparatus 300 as a bird's-eye view camera, and the second image capture apparatus 400 as a sub-camera hereinafter.

### <Apparatus Configuration>

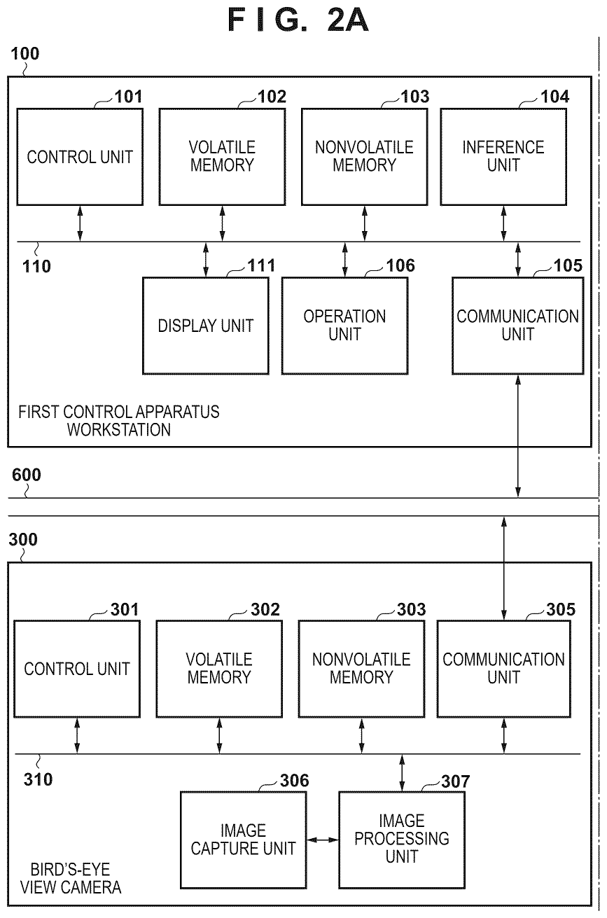

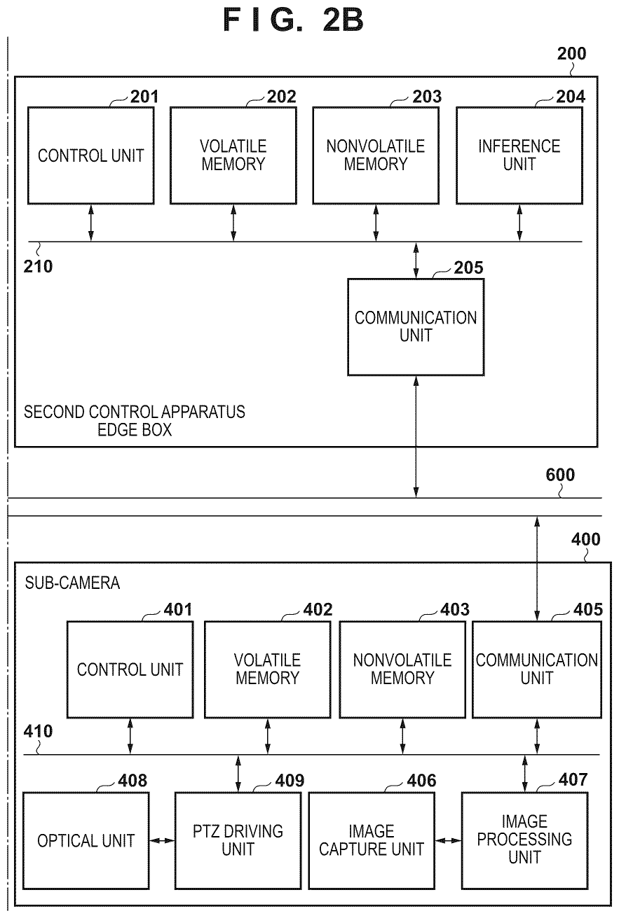

The hardware configurations of the WS 100, the EB 200, the bird's-eye view camera 300, and the sub-camera 400 will be described next in detail with reference to FIGS. 2A and 2B.

First, the configuration of the WS 100 will be described.

The WS 100 includes a control unit 101, a volatile memory 102, a nonvolatile memory 103, an inference unit 104, a communication unit 105, and an operation unit 106, and the units are connected to be able to transmit/receive data via an internal bus 110.

The control unit 101 includes a processor (CPU) that performs arithmetic processing and control processing of the WS 100, and executes control programs stored in the nonvolatile memory 103, thereby controlling the components of the WS 100.

The volatile memory 102 is a main storage device such as a RAM. Constants and variables for the operations of the control unit 101 and control programs and an inference program read out from the nonvolatile memory 103 are loaded into the volatile memory 102. Also, the volatile memory 102 stores pieces of information such as image data that the communication unit 105 receives from an external apparatus and the inference program. Additionally, the volatile memory 102 stores bird's-eye view image data received from the bird's-eye view camera 300. The volatile memory 102 has a sufficient storage capacity to hold these pieces of information.

The nonvolatile memory 103 is an auxiliary storage device such as an EEPROM, a flash memory, a hard disk drive (HDD), a solid state drive (SSD), or a memory card. The nonvolatile memory 103 stores an operating system (OS) that is basic software to be executed by the control unit 101, control programs including applications that implement applied functions in cooperation with the OS, and the inference program to be used by the inference unit 104 for inference processing.

The inference unit 104 executes inference processing using a learned inference model and inference parameters in accordance with the inference program. The inference unit 104 executes inference processing of estimating the presence/absence or the position of a specific subject and the feature information of the subject from a bird's-eye view image received from the bird's-eye view camera 300. The inference processing in the inference unit 104 can be executed by an arithmetic processing device such as a Graphics Processing Unit (GPU) specialized to image processing or inference processing. The GPU is a processor capable of performing many product-sum operations, and has an arithmetic processing capability for performing a matrix operation of a neural network in a short time. The inference processing in the inference unit 104 may be implemented by a reconfigurable logic circuit such as a Field-Programmable Gate Array (FPGA). Note that for the inference processing, the CPU of the control unit 101 and the GPU may perform operations in cooperation, or one of the CPU of the control unit 101 and the GPU may perform operations.

The communication unit 105 is an interface (I/F) complying with a wired communication standard such as Ethernet (Registered Trademark) or an interface complying with a wireless communication standard such as Wi-Fi (Registered Trademark). The communication unit 105 can be connected to an external apparatus such as the EB 200, the bird's-eye view camera 300, or the sub-camera 400 via the network 600 such as a wired LAN or a wireless LAN and transmit/receive data to/from the external apparatus. The control unit 101 controls the communication unit 105, thereby implementing communication with the external apparatus. Note that the communication method is not limited to Ethernet (Registered Trademark) or Wi-Fi (Registered Trademark), and a communication standard such as IEEE 1394 may be used.

The operation unit 106 is an operation member such as various switches, buttons, or a touch panel, which accepts various kinds of operations of the user and outputs operation information to the control unit 101. Also, the operation unit 106 provides a user interface used by the user to operate the WS 100.

A display unit 111 displays a bird's-eye view image or a subject recognition result, and displays a Graphical User Interface (GUI) for an interactive operation. The display unit 111 is a display device such as a liquid crystal display or an organic EL display. The display unit 111 may be integrated with the WS 100 or may be an external device connected to the WS 100.

The configuration of the EB 200 will be described next.

The EB 200 includes a control unit 201, a volatile memory 202, a nonvolatile memory 203, an inference unit 204, and a communication unit 205, and the units are connected to be able to transmit/receive data via an internal bus 210.

The control unit 201 includes a processor (CPU) that performs arithmetic processing and control processing of the EB 200, and executes control programs stored in the nonvolatile memory 203, thereby controlling the components of the EB 200.

The volatile memory 202 is a main storage device such as a RAM. Constants and variables for the operations of the control unit 201 and control programs and an inference program read out from the nonvolatile memory 203 are loaded into the volatile memory 202. Also, the volatile memory 202 stores pieces of information such as image data that the communication unit 205 receives from an external apparatus and the inference program. Additionally, the volatile memory 202 stores sub-image data received from the sub-camera 400. The volatile memory 202 has a sufficient storage capacity to hold these pieces of information.

The nonvolatile memory 203 is an auxiliary storage device such as an EEPROM, a flash memory, a hard disk drive (HDD), a solid state drive (SSD), or a memory card. The nonvolatile memory 203 stores an operating system (OS) that is basic software to be executed by the control unit 201, control programs including applications that implement applied functions in cooperation with the OS, and the inference program to be used by the inference unit 204 for inference processing.

The inference unit 204 executes inference processing using a learned inference model and inference parameters in accordance with the inference program. The inference unit 204 executes inference processing of estimating the presence/absence or the position of a specific subject and the feature information of the subject from a sub-image received from the sub-camera 400. The inference processing in the inference unit 204 can be executed by an arithmetic processing device such as a Graphics Processing Unit (GPU) specialized to image processing or inference processing. The GPU is a processor capable of performing many product-sum operations, and has an arithmetic processing capability for performing a matrix operation of a neural network in a short time. The inference processing in the inference unit 204 may be implemented by a reconfigurable logic circuit such as a Field-Programmable Gate Array (FPGA). Note that for the inference processing, the CPU of the control unit 201 and the GPU may perform operations in cooperation, or one of the CPU of the control unit 201 and the GPU may perform operations.

The communication unit 205 is an interface (I/F) complying with a wired communication standard such as Ethernet (Registered Trademark) or an interface complying with a wireless communication standard such as Wi-Fi (Registered Trademark). The communication unit 205 can be connected to an external apparatus such as the WS 100 or the sub-camera 400 via the network 600 such as a wired LAN or a wireless LAN and transmit/receive data to/from the external apparatus. The control unit 201 controls the communication unit 205, thereby implementing communication with the external apparatus. Note that the communication method is not limited to Ethernet (Registered Trademark) or Wi-Fi (Registered Trademark), and a communication standard such as IEEE 1394 may be used.

The configuration of the bird's-eye view camera 300 will be described next.

The bird's-eye view camera 300 includes a control unit 301, a volatile memory 302, a nonvolatile memory 303, a communication unit 305, an image capture unit 306, and an image processing unit 307, and the units are connected to be able to transmit/receive data via an internal bus 310.

The control unit 301 comprehensively controls the whole bird's-eye view camera 300 under the control of the WS 100. The control unit 301 includes a processor (CPU) that performs arithmetic processing and control processing of the bird's-eye view camera 300, and executes control programs stored in the nonvolatile memory 303, thereby controlling the components of the bird's-eye view camera 300.

The volatile memory 302 is a main storage device such as a RAM. Constants and variables for the operations of the control unit 301 and control programs and an inference program read out from the nonvolatile memory 303 are loaded into the volatile memory 302. Also, the volatile memory 302 stores bird's-eye view image data captured by the image capture unit 306 and processed by the image processing unit 307. The volatile memory 302 has a sufficient storage capacity to hold these pieces of information.

The nonvolatile memory 303 is an auxiliary storage device such as an EEPROM, a flash memory, a hard disk drive (HDD), a solid state drive (SSD), or a memory card. The nonvolatile memory 303 stores an operating system (OS) that is basic software to be executed by the control unit 301, and control programs including applications that implement applied functions in cooperation with the OS.

The image capture unit 306 includes an image sensor formed by a Charge Coupled Device (CCD) or a Complementary Metal-Oxide-Semiconductor (CMOS) element, and converts an optical image of a subject into an electrical signal. In the present embodiment, the image capture angle of view of the bird's-eye view camera 300 is fixed such that it can capture a bird's-eye view image including a plurality of subjects including a tracking subject.

The image processing unit 307 executes various kinds of image processing for image data output from the image capture unit 306 or image data read out from the volatile memory 302. The various kinds of image processing include, for example, image processing such as noise removal, edge enhancement, and enlargement/reduction, image correction processing such as contrast correction, brightness correction, and color correction, and trimming processing or crop processing of cutting out a part of image data. The image processing unit 307 converts the image data that has undergone the image processing into an image file having a predetermined format (for example, JPEG) and records it in the nonvolatile memory 303. Also, the image processing unit 307 performs predetermined arithmetic processing using image data, and the control unit 301 performs auto-focus (AF) processing and auto-exposure (AE) processing based on the operation result.

The communication unit 305 is an interface (I/F) complying with a wired communication standard such as Ethernet (Registered Trademark) or an interface complying with a wireless communication standard such as Wi-Fi (Registered Trademark). The communication unit 305 can be connected to an external apparatus such as the WS 100 via the network 600 such as a wired LAN or a wireless LAN and transmit/receive data to/from the external apparatus. The control unit 301 controls the communication unit 305, thereby implementing communication with the external apparatus. Note that the communication method is not limited to Ethernet (Registered Trademark) or Wi-Fi (Registered Trademark), and a communication standard such as IEEE 1394 may be used.

The configuration of the sub-camera 400 will be described next.

The sub-camera 400 includes a control unit 401, a volatile memory 402, a nonvolatile memory 403, a communication unit 405, an image capture unit 406, an image processing unit 407, an optical unit 408, and a PTZ driving unit 409, and the units are connected to be able to transmit/receive data via an internal bus 410.

The control unit 401 generally controls the whole sub-camera 400 under the control of the WS 100 or the EB 200. The control unit 401 includes a processor (CPU) that performs arithmetic processing and control processing of the sub-camera 400, and executes control programs stored in the nonvolatile memory 403, thereby controlling the components of the sub-camera 400.

The volatile memory 402 is a main storage device such as a RAM. Constants and variables for the operations of the control unit 401 and control programs and an inference program read out from the nonvolatile memory 403 are loaded into the volatile memory 402. Also, the volatile memory 402 stores bird's-eye view image data captured by the image capture unit 406 and processed by the image processing unit 407. The volatile memory 402 has a sufficient storage capacity to hold these pieces of information.

The nonvolatile memory 403 is an auxiliary storage device such as an EEPROM, a flash memory, a hard disk drive (HDD), a solid state drive (SSD), or a memory card. The nonvolatile memory 403 stores an operating system (OS) that is basic software to be executed by the control unit 401, and control programs including applications that implement applied functions in cooperation with the OS.

The image capture unit 406 includes an image sensor formed by a Charge Coupled Device (CCD) or a Complementary Metal-Oxide-Semiconductor (CMOS) element, and converts an optical image of a subject into an electrical signal.

The image processing unit 407 executes various kinds of image processing for image data output from the image capture unit 406 or image data read out from the volatile memory 402. The various kinds of image processing include, for example, image processing such as noise removal, edge enhancement, and enlargement/reduction, image correction processing such as contrast correction, brightness correction, and color correction, and trimming processing or crop processing of cutting out a part of image data. The image processing unit 407 converts the image data that has undergone the image processing into an image file having a predetermined format (for example, JPEG) and records it in the nonvolatile memory 403. Also, the image processing unit 407 performs predetermined arithmetic processing using image data, and the control unit 401 performs auto-focus (AF) processing and auto-exposure (AE) processing based on the operation result.

The communication unit 405 is an interface (I/F) complying with a wired communication standard such as Ethernet (Registered Trademark) or an interface complying with a wireless communication standard such as Wi-Fi (Registered Trademark). The communication unit 405 can be connected to an external apparatus such as the EB 200 via the network 600 such as a wired LAN or a wireless LAN and transmit/receive data to/from the external apparatus. The control unit 401 controls the communication unit 405, thereby implementing communication with the external apparatus. Note that the communication method is not limited to Ethernet (Registered Trademark) or Wi-Fi (Registered Trademark), and a communication standard such as IEEE 1394 may be used.

The optical unit 408 includes a lens group including a zoom lens and a focus lens, a shutter having an aperture function, and a mechanism that drives these optical members. The optical unit 408 drives the optical members to perform at least one of rotating the image capture direction of the sub-camera 400 about a pan (P) axis (horizontal direction) or a tilt (T) axis (vertical direction) and changing the image capture range (image capture angle of view) of the sub-camera 400 along a zoom (Z) axis (enlargement/reduction direction).

The PTZ driving unit 409 includes mechanical elements configured to drive the optical unit 408 in the PTZ direction and an actuator such as a motor, and drives the optical unit 408 in the PTZ direction under the control of the control unit 401.

Note that the zoom function according to the present embodiment is not limited to optical zoom that changes the focal length by moving the zoom lens and may be digital zoom that extracts a part of captured image data and enlarges it, or optical zoom and digital zoom may be combined.

### [Control Processing]

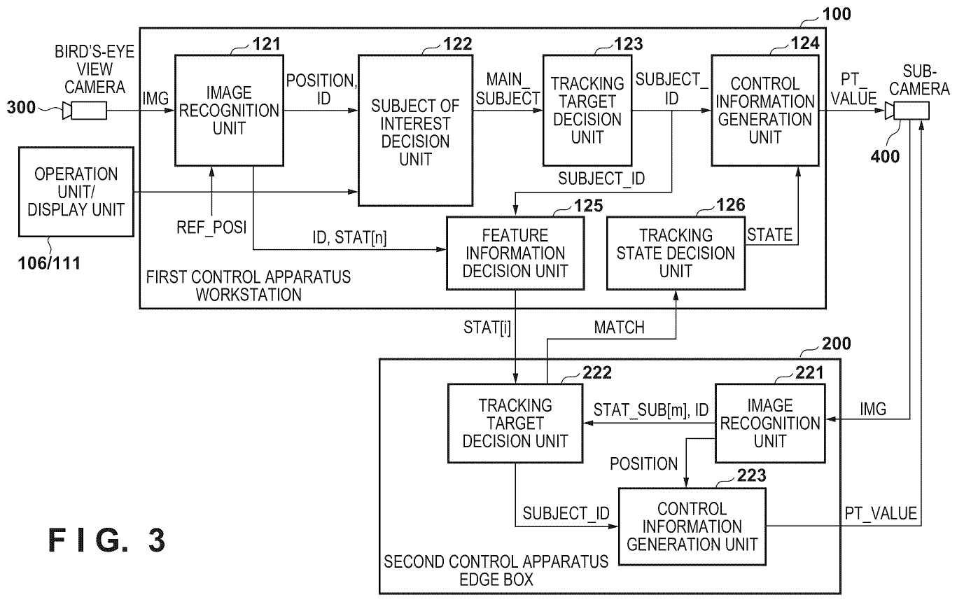

Control processing of tracking a tracking subject by switching between a mode in which the WS 100 controls the sub-camera 400 based on a bird's-eye view image and a mode in which the EB 200 controls the sub-camera 400 based on a sub-image will be described next with reference to FIGS. 3 to 10A to 10F.

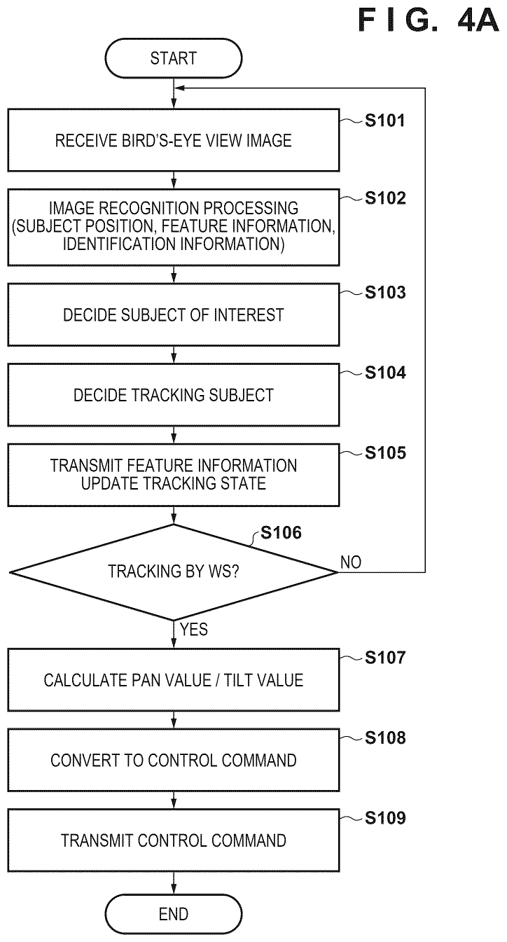

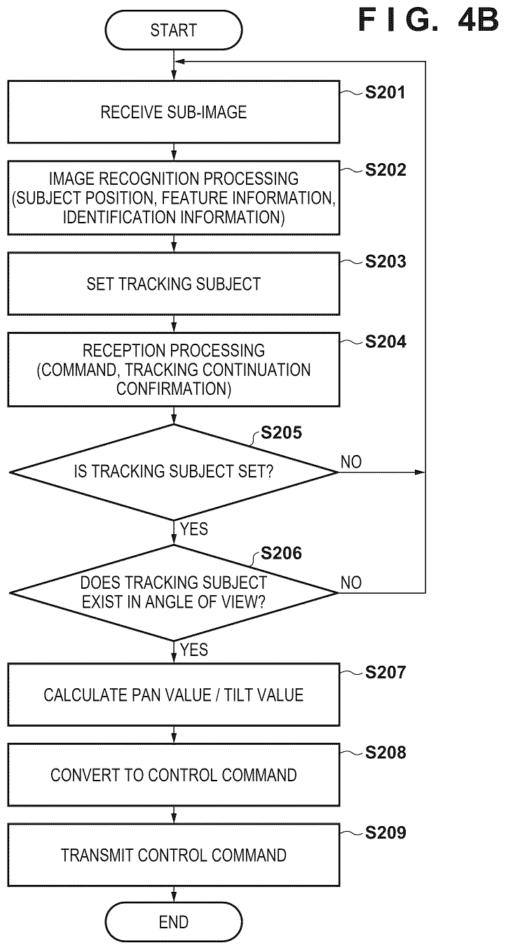

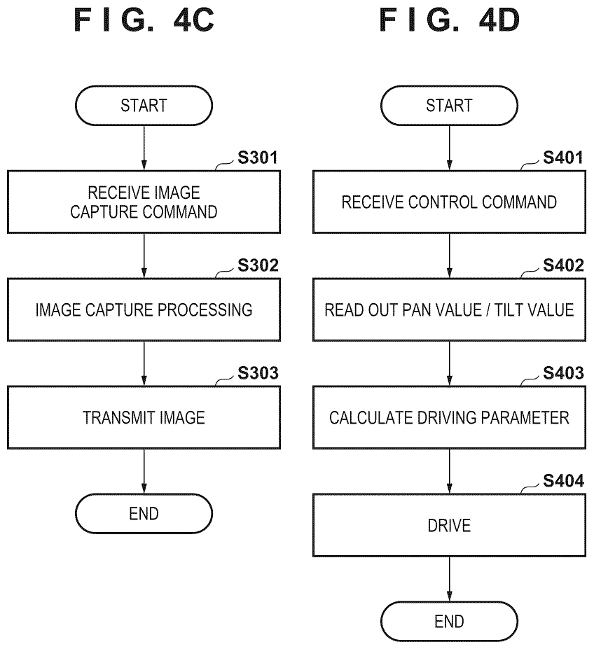

First, the functional configurations of the WS 100 and the EB 200 configured to implement the control processing according to the present embodiment will be described with reference to FIGS. 3 and 4A to 4D.

The functions of the WS 100 and the EB 200 are implemented by hardware and/or software. Note that when the function units shown in FIG. 3 are not implemented by software but configured by hardware, a circuit configuration corresponding to each function unit shown in FIG. 3 is provided.

The WS 100 includes an image recognition unit 121, a subject of interest decision unit 122, a tracking target decision unit 123, a control information generation unit 124, a feature information decision unit 125, and a tracking state decision unit 126. The pieces of software configured to implement these functions are stored in the nonvolatile memory 103, and the control unit 101 loads these into the volatile memory 102 and executes them.

The EB 200 includes an image recognition unit 221, a tracking target decision unit 222, and a control information generation unit 223. These pieces of software are stored in the nonvolatile memory 203, and the control unit 201 loads these into the volatile memory 202 and executes them.

FIG. 4A is a flowchart showing the basic operation of the WS 100. FIG. 4B is a flowchart showing the basic operation of the EB 200. FIG. 4C is a flowchart showing the operation of the bird's-eye view camera 300. FIG. 4D is a flowchart showing the operation of the sub-camera 400.

First, the functions and the basic operation of the software of the WS 100 will be described with reference to FIGS. 3 and 4A.

In step S101, the control unit 101 transmits an image capture command to the bird's-eye view camera 300 via the communication unit 105 using a predetermined protocol, receives a bird's-eye view image from the bird's-eye view camera 300, stores it in the volatile memory 102, and advances the process to step S102.

In step S102, the control unit 101 executes the function of the image recognition unit 121 shown in FIG. 3, and advances the process to step S103.

The image recognition unit 121 controls the inference unit 104, the volatile memory 102, and the nonvolatile memory 103 and performs following subject recognition processing.

A bird's-eye view image IMG of the bird's-eye view camera 300 and reference position information REF_POSI of the bird's-eye view camera 300, which are read out from the volatile memory 102, are input to the image recognition unit 121. The reference position information REF_POSI of the bird's-eye view camera 300 includes the information of the position of the bird's-eye view camera 300 and marker coordinates. The image recognition unit 121 performs detection of a subject and calculation of feature information based on the bird's-eye view image IMG and the reference position information REF_POSI of the bird's-eye view camera 300. The image recognition unit 121 then outputs coordinate information POSITION[n] indicating the position of the detected subject, ID[n] indicating the identification information of the detected subject, and STAT[n] indicating the feature information of the detected subject.

The position of the bird's-eye view camera 300 is a position in a coordinate space that views the image capture region of the bird's-eye view camera 300 from directly above, and the position is measured in advance by a user operation or a sensor (not shown) and known. The marker coordinates are the position information of a marker set in the coordinate space that views the image capture region of the bird's-eye view camera 300 from directly above to calculate a homography transformation matrix to be described later and are known values measured in advance manually or using a sensor (not shown). The marker is a mark having a color different from the color of a floor or ground, and any marker can be used when it can be measured by a user operation or a sensor (not shown). For example, when the sensor (not shown) is a camera, a mark having an arbitrary color is used as a marker, and the marker position is obtained by extracting the color of the marker from a captured image.

Also, a user may input the position of the bird's-eye view camera 300 and the marker coordinates via the operation unit 106 of the WS 100, and the control unit 101 may store these in the volatile memory 102. The reference position information REF_POSI and the coordinate information POSITION[n] of the subject are represented on a coordinate system converted into the coordinate space that views the image capture region of the bird's-eye view camera 300 from directly above. n is an index indicating the number of detected subjects. For example, when the inference unit 104 detects three persons, POSITION, ID, and STAT of the three persons are output as the inference result. The control unit 101 stores, in the volatile memory 102, the subject recognition result by the image recognition unit 121. Details of subject detection processing and feature information calculation processing will be described later.

A calculation method of the coordinate information POSITION of a subject by the image recognition unit 121 will be described here.

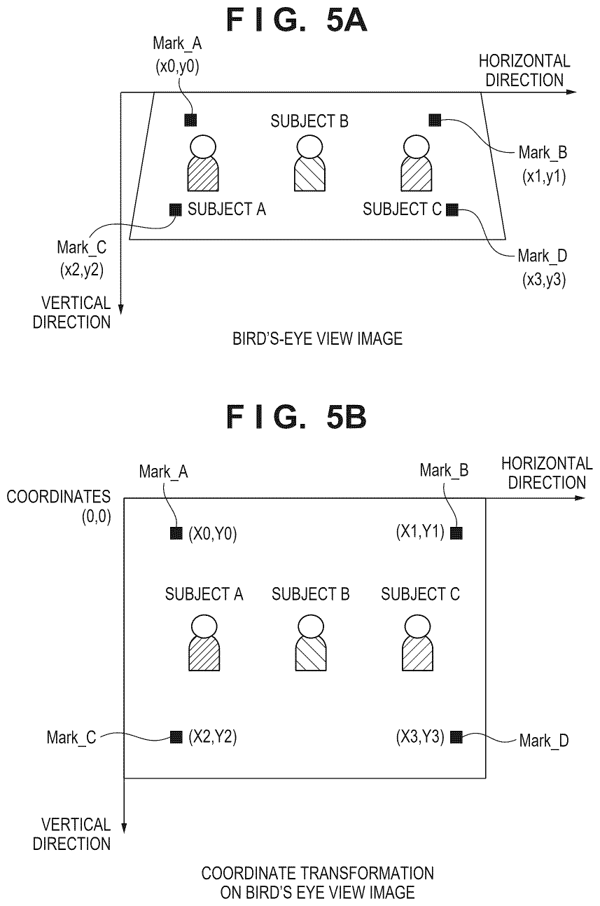

First, the relationship between the coordinate system of the bird's-eye view image of the bird's-eye view camera 300 and the coordinate system that views the image capture region of the bird's-eye view camera 300 from directly above will be described with reference to FIGS. 5A and 5B.

To calculate a pan value with which the image capture direction of the sub-camera 400 is the direction of the tracking subject, the operation can be facilitated by calculating an angle in a plane coordinate space perpendicular to the axis to perform the pan operation by the sub-camera 400. For example, when the sub-camera 400 is installed perpendicular to a ground surface (reference position) such as a floor or ground, the coordinate space perpendicular to the axis to perform the pan operation by the sub-camera 400 is a coordinate space parallel to the reference position (a coordinate space that views the space where the sub-camera 400 or a subject exists from directly above) shown in FIG. 5B.

In the present embodiment, the sub-camera 400 is installed perpendicular to the reference position, and the pan value is calculated on a coordinate system that views the image capture region of the bird's-eye view camera 300 from directly above. That is, the coordinates of a subject position detected in the coordinate system of a bird's-eye view image of the bird's-eye view camera 300 (to be referred to as a bird's-eye view camera coordinate system hereinafter) shown in FIG. 5A are transformed to those in the coordinate system that views the image capture region of the bird's-eye view camera 300 from directly above (to be referred to as a plane coordinate system hereinafter) shown in FIG. 5B. The coordinate transformation is performed, using a homography transformation matrix H, by

$$( \begin{matrix}X \\ Y \\ W\end{matrix} ) = H ( \begin{matrix}x \\ y \\ 1\end{matrix} ) \qquad ( 1 )$$

In equation (1), x and y are the horizontal and vertical coordinates on the bird's-eye view camera coordinate system, and X and Y are the horizontal and vertical coordinates on the plane coordinate system.

The control unit 101 reads out the reference position information REF_POSI from the volatile memory 102 and substitutes marker coordinates Mark_A to Mark_D shown in FIGS. 5A and 5B, which are included in the reference position information REF_POSI, into equation (1), thereby calculating the homography transformation matrix H. Note that the marker coordinates are values on the plane coordinate system. By using equation (1), arbitrary coordinates on the bird's-eye view camera coordinate system in FIG. 5A can be mapped to arbitrary coordinates on the plane coordinate system in FIG. 5B. In the example shown in FIGS. 5A and 5B, the control unit 101 can ascertain, on the plane coordinate system shown in FIG. 5B, the positions of the subject A, the subject B, and the subject C included in the bird's-eye view image IMG of the bird's-eye view camera 300. The control unit 101 stores the homography transformation matrix H calculated by equation (1) in the volatile memory 102.

A method of detecting a subject position using an inference model for subject detection and a method of transformation to the plane coordinate system will be described next.

In the present embodiment, subject detection is performed by performing image recognition processing using a learned inference model for subject detection, which is created by performing machine learning such as deep learning.

The inference model for subject detection receives a bird's-eye view image as an input, and outputs coordinate information, on the image, of a subject included in the bird's-eye view image.

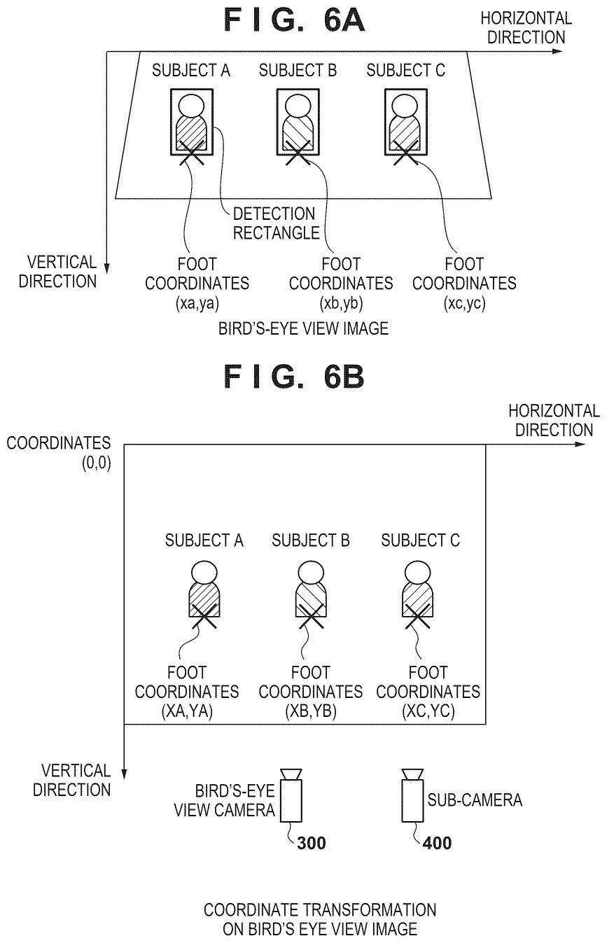

The control unit 101 receives, by the inference unit 104, the bird's-eye view image IMG of the bird's-eye view camera 300 as an input, and performs image recognition processing using the inference model for subject detection, thereby detecting a subject. FIG. 6A shows an example in which each subject detected by the inference unit 104 is displayed in a rectangular frame. As shown in FIG. 6A, the coordinates of rectangular portions bounding the subject A, the subject B, and the subject C detected from the bird's-eye view image are detected as subject positions. The control unit 101 stores, in the volatile memory 102, the coordinate information of the subjects detected from the bird's-eye view image. Note that in the present embodiment, an example in which subject detection is performed by inference processing using a learned model has been described. However, the present disclosure is not limited to this. For example, a method called a SIFT method that performs detection by collating local feature points in an image or a method called a template matching method that performs detection by obtaining a similarity to a template image may be used.

Furthermore, the control unit 101 transforms the lower end of the rectangular portion of each subject detected on the bird's-eye view camera coordinate system shown in FIG. 6A as a subject detection position (the foot coordinates of the person in the example shown in FIG. 6A) to the plane coordinate system shown in FIG. 6B. For example, the control unit 101 reads out the homography transformation matrix H from the volatile memory 102, and substitutes foot coordinates (xa, ya) of the subject A on the bird's-eye view camera coordinate system to x and y of equation (1), thereby transforming the coordinates to foot coordinates (XA, YA) on the plane coordinate system.

As for foot coordinates (xb, yb) of the subject B and foot coordinates (xc, yc) of the subject C as well, foot coordinates (XB, YB) of the subject B and foot coordinates (XC, YC) of the subject C on the plane coordinate system can be calculated. The control unit 101 writes the foot coordinates as the position coordinates POSITION of the subjects in the volatile memory 102.

A method of generating the subject identification information ID and the feature information STAT by the image recognition unit 121 will be described next.

The control unit 101 inputs, by the inference unit 104, the position coordinate POSITION of the subject that is the inference result of the inference model for subject detection and the bird's-eye view image of the bird's-eye view camera 300 to a learned inference model for subject specifying created by performing machine learning such as deep learning and performs inference processing, thereby outputting the identification information ID and the feature information STAT. The inference model for subject specifying is different from the inference model for subject detection.

The inference model for subject specifying will be described here.

The inference model for subject specifying according to the present embodiment is a learned model that has learned using learning data obtained by collecting data that associates a set of images obtained by capturing a specific subject from a plurality of different image capture directions with information capable of identifying the specific subject as many as the number of a plurality of subjects such that the similarity of feature information is high between images of the same subject. When an image of a subject cut out based on the coordinate information POSITION of the subject as the output of the inference model for subject detection is input to the inference model for subject specifying, the feature information STAT is output.

When images of the same subject captured by different cameras are input, output feature information has a high similarity to the feature information STAT, as compared to a case where images of different subjects are input. As the feature information, a multidimensional vector of a response of a convolutional layer of a convolutional neural network can be used. The similarity will be described later.

The inference model for subject detection and the inference model for subject specifying are stored in the nonvolatile memory 103 before the start of control processing according to the present embodiment.

Also, the image recognition unit 121 adds the identification information ID of the subject corresponding to the feature information that is the inference result of the inference model for subject specifying. Furthermore, the image recognition unit 121 calculates the similarity between feature information of images of each subject obtained by inputting, to the inference model for subject specifying, images of each subject detected by the inference model for subject detection using each of the image of a current frame and the image of a past frame as an input. The similarity is calculated using a cosine similarity.

The more similar the multidimensional vectors that are the feature information of subject images are, the closer the cosine similarity is to 1. The more different the multidimensional vectors are, the closer the cosine similarity is to 0. The same ID is added to subjects having the highest similarity between the past frame and the current frame. Note that the similarity calculation method is not limited to this, and any method is usable when it outputs a high numerical value when the pieces of feature information are close, and outputs a low numerical value when the pieces of feature information are far. Note that in the present embodiment, feature information is used to add an ID, but the present disclosure is not limited to this. The positions or sizes of the rectangular information of the detected subjects may be compared between the current frame and the past frame using the rectangular information of the subjects obtained by the inference model for subject detection, and the same ID may be added to closest subjects. Alternatively, the position of the rectangular information of the current frame may be predicted using a Kalman filter or the like from the transition of the position of the rectangular information for the same ID in several past frames, and the same ID may be added to a subject closest to the predicted position of the rectangular information. The ID may be added by combining these methods.

When this method is used, it is possible to improve the correctness of ID addition in a case where a subject with a similar appearance abruptly enters the image capture angle of view.

As described above, the image recognition unit 121 receives the bird's-eye view image of the bird's-eye view camera 300 as an input and performs inference processing using the inference model for subject detection, thereby outputting the coordinate position of each subject and storing it in the volatile memory 102. Also, the image recognition unit 121 inputs the coordinate information POSITION of the subject that is the inference result of the inference model for subject detection and the bird's-eye view image of the bird's-eye view camera 300 to the inference model for subject specifying, and performs inference processing. The image recognition unit 121 outputs the identification information ID and the feature information STAT as the result of the inference processing, and stores these in the volatile memory 102.

Referring back to FIG. 4A, in step S103, the control unit 101 executes the function of the subject of interest decision unit 122 shown in FIG. 3, and advances the process to step S104.

The subject of interest decision unit 122 decides a subject of interest MAIN_SUBJECT from operation information input by the user via the operation unit 106 and the coordinate information of each subject, which is a subject recognition result by the image recognition unit 121 read out from the volatile memory 102.

The control unit 101 displays, on the display unit 111 of the WS 100, the bird's-eye view image of the bird's-eye view camera 300 and the subject recognition result stored in the volatile memory 102. The control unit 101 selects a subject of interest from the subjects displayed as the subject recognition result by the user via the operation unit 106. For example, when the operation unit 106 is a mouse, the user can select one of the subjects displayed on the display unit 111 by clicking it. The control unit 101 stores the identification information ID corresponding to the subject of interest selected by the user in the volatile memory 102 as the subject of interest MAIN_SUBJECT.

In step S104, the control unit 101 executes the function of the tracking target decision unit 123 shown in FIG. 3, and advances the process to step S105.

The tracking target decision unit 123 decides a tracking subject SUBJECT_ID of the sub-camera 400 from the subject of interest MAIN_SUBJECT decided by the subject of interest decision unit 122.

The method of deciding the tracking subject of the sub-camera 400 will be described here.

The control unit 101 reads out the subject of interest MAIN_SUBJECT decided by the subject of interest decision unit 122 from the volatile memory 102, and decides the subject of interest MAIN_SUBJECT as the tracking subject SUBJECT_ID of the sub-camera 400. When the same subject as the subject of interest MAIN_SUBJECT selected by the user is set to the tracking subject SUBJECT_ID of the sub-camera 400, the sub-camera 400 can be controlled using the subject selected by the user as the tracking target.

The tracking subject decision method is not limited to the above-described method and, for example, the tracking subject may be decided using the information of the subject of interest MAIN_SUBJECT and the identification information ID read out from the volatile memory 102. For example, in a case where the bird's-eye view image of the bird's-eye view camera 300 includes a plurality of subjects, and a plurality of sub-cameras 400 are installed, one sub-camera may set the same subject as the subject of interest as the tracking target, and another sub-camera may set a subject different from the subject of interest as the tracking target. When the tracking subject is decided in this way, the plurality of subjects included in the bird's-eye view image of the bird's-eye view camera 300 can comprehensively be tracked for each sub-camera.

Also, the reference position information REF_POSI including the coordinate information POSITION and the identification information ID of the subject, and the sub-camera position may be read out from the volatile memory 102, and among subjects detected from the bird's-eye view image of the bird's-eye view camera 300, a subject closest to the sub-camera may be decided as the tracking subject. When the tracking subject is decided in this way, a subject that can readily be set in the angle of view from the position of the sub-camera can be decided as the tracking subject. The control unit 101 stores the thus decided tracking subject SUBJECT_ID in the volatile memory 102, and stores the identification information ID of the tracking subject before storage in the volatile memory 102 as a tracking subject ID in the past.

In step S105, the control unit 101 executes the function of the feature information decision unit 125, and transmits feature information corresponding to the tracking subject of the sub-camera 400 to the EB 200. Also, the control unit 101 executes the function of the tracking state decision unit 126, updates tracking state information STATE, stores it in the volatile memory 102, and advances the process to step S106.

The tracking state information STATE includes information of one of “tracking by the WS 100” and “tracking by the EB 200”. “Tracking by the WS 100” indicates a state in which the WS 100 is tracking the tracking subject by controlling the sub-camera 400. “Tracking by the EB 200” indicates a state in which the EB 200 is tracking the tracking subject by controlling the sub-camera 400. Details of the process of step S105 will be described later.

In step S106, the control unit 101 reads out the tracking state information STATE from the volatile memory 102, and determines, based on the tracking state information STATE, whether it indicates “tracking by the WS 100” or “tracking by the EB 200”. Upon determining that the tracking state information STATE indicates “tracking by the WS 100”, the control unit 101 advances the process to step S107. Upon determining that the tracking state information STATE indicates “tracking by the EB 200”, the control unit 101 returns the process to step S101.

In step S107, the control unit 101 executes the function of the control information generation unit 124 shown in FIG. 3, and advances the process to step S108.

The control information generation unit 124 calculates a pan value/tilt value PT_VALUE of the sub-camera 400 to track the tracking subject SUBJECT_ID decided by the tracking target decision unit 123 by the sub-camera 400. The control unit 101 reads out, from the volatile memory 102, the coordinate information of the sub-camera 400 on the plane coordinate system included in the reference position information REF_POSI and the coordinate information POSITION of the detected subject. The control unit 101 then calculates, from the coordinate information of the subject corresponding to the tracking subject SUBJECT_ID, the pan value/tilt value with which the image capture direction of the sub-camera 400 is the direction of the tracking subject.

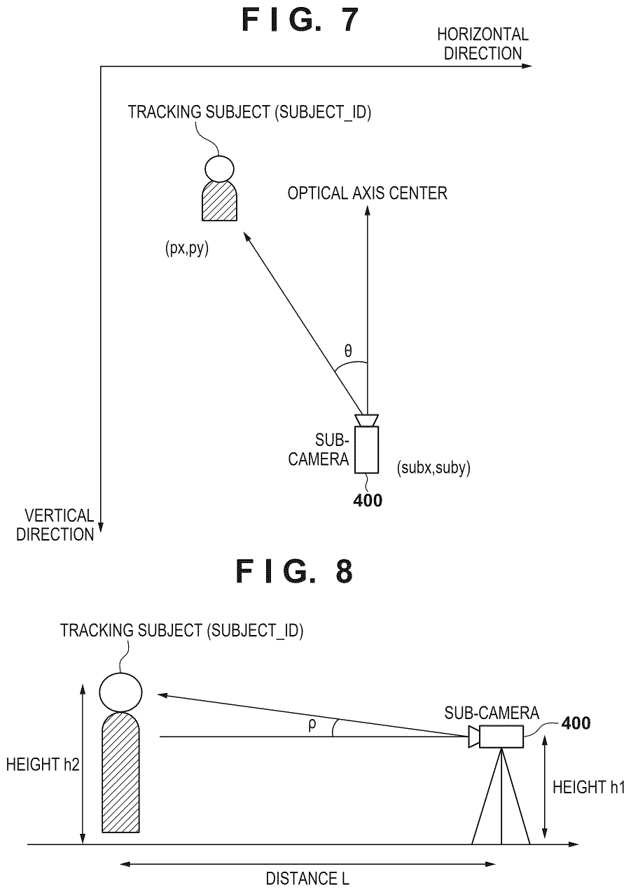

The pan value calculation method will be described here with reference to FIG. 7.

As shown in FIG. 7, an angle θ made by the extended line of the optical axis center of the sub-camera 400 and a line that connects the sub-camera 400 and the tracking subject SUBJECT_ID can be calculated by

$$θ = {tan}^{- 1} \frac{px - subx}{py - suby} ( rad ) \qquad ( 2 )$$

In equation (2), px and py are the horizontal and vertical coordinates of the position of the tracking subject, and subx and suby are the horizontal and vertical coordinates of the position of the sub-camera 400. px and py can be obtained by referring to coordinate information corresponding to the tracking subject SUBJECT_ID from the coordinate information POSITION of the detected subject.

The control information generation unit 124 calculates the pan value of the sub-camera 400 based on the angle θ.

A tilt control value calculation method will be described next with reference to FIG. 8.

As shown in FIG. 8, defining the height of the optical axis of the sub-camera 400 as h1, an angle ρ made by the extended line of the optical axis center of the sub-camera 400 and a line extended to a height h2 of a predetermined part of the tracking subject (the height of the face when the subject is a person) can be calculated by

$$L = \sqrt{{( px - subx )}^{2} + {( py - suby )}^{2}} \qquad ( 3 )$$

$$ρ = {tan}^{- 1} \frac{h 2 - h 1}{L} ( rad ) \qquad ( 4 )$$

In equation (4), h1 is the height of the sub-camera 400 from the ground surface, and h2 is the height from the ground surface to a predetermined part of the tracking subject (the face when the subject is a person). h1 and h2 may be held in the volatile memory 102 in advance, or may be measured in real time using a sensor (not shown).

The control information generation unit 124 calculates the tilt control value of the sub-camera 400 based on the angle ρ.

Note that the pan value/tilt value may be a speed value to direct the sub-camera 400 toward the tracking subject. As for the method of calculating the pan value/tilt value, first, the control unit 101 obtains the current pan value/tilt value of the sub-camera 400 from the EB 200. Next, the control unit 101 obtains the angular velocity of pan proportional to the difference to the pan value θ read out from the volatile memory 102. In addition, the control unit 101 obtains the angular velocity of tilt proportional to the difference to the tilt control value ρ read out from the volatile memory 102. The control unit 101 then stores the calculated control values in the volatile memory 102.

In step S108, the control unit 101 reads out the pan value/tilt value from the volatile memory 102, converts these into a control command in accordance with a predetermined protocol for controlling the sub-camera 400, stores it in the volatile memory 102, and advances the process to step S109.

In step S109, the control unit 101 transmits the control command according to the pan value/tilt value calculated in step S108 to the sub-camera 400 via the communication unit 105, and returns the process to step S101.

The basic operation of the WS 100 has been described above.

The functions and the basic operation of the EB 200 will be described next with reference to FIGS. 3 and 4B.

In step S201, the control unit 201 transmits an image capture command to the sub-camera 400 via the communication unit 205, receives a captured sub-image from the sub-camera 400, stores it in the volatile memory 202, and advances the process to step S202.

In step S202, the control unit 201 executes the function of the image recognition unit 221 shown in FIG. 3, and advances the process to step S203.

The image recognition unit 221 has the same function as the image recognition unit 121 of the WS 100.

The control unit 201 inputs, by the inference unit 204, the sub-image of the sub-camera 400 read out from the volatile memory 202 to a learned model created by performing machine learning such as deep learning, and performs inference processing. The inference result includes the coordinate information POSITION and feature information STAT_SUB[m] of each subject detected from sub-image of the sub-camera 400 and the identification information ID of each subject, and is stored in the volatile memory 202. Note that the learned model used for inference processing of the image recognition unit 221 is a model common to the learned model used by the image recognition unit 121 of the WS 100 (an inference model for subject detection and an inference model for subject specifying).

In step S203, the control unit 201 receives the feature information STAT of the subject from the WS 100 via the communication unit 205, and collates it with the feature information STAT_SUB calculated from the sub-image of the sub-camera 400 using the function of the tracking target decision unit 222 shown in FIG. 3. When a subject whose feature information STAT and feature information STAT_SUB have a high similarity exists in the image capture angle of view of the sub-camera 400, the control unit 201 decides the identification information ID of the subject as the identification information ID=SUBJECT_ID of the subject to be tracked by the sub-camera 400, stores it in the volatile memory 202, and advances the process to step S204. Details of the similarity calculation method will be described later.

In step S204, the control unit 201 performs, via the communication unit 205, tracking stop processing or confirmation of a communication state for continuing tracking for the WS 100 and processing according to communication contents, and advances the process to step S205. Details of the process of step S204 will be described later.

In step S205, the control unit 201 determines whether the information of the tracking subject SUBJECT_ID is stored in the volatile memory 202. Upon determining that the information of the tracking subject SUBJECT_ID is stored in the volatile memory 202, that is, the identification information ID of the tracking subject of the sub-camera 400 is stored in the volatile memory 202, the control unit 201 advances the process to step S206. Upon determining that the information of the tracking subject SUBJECT_ID is not stored in the volatile memory 202, that is, the identification information ID of the tracking subject of the sub-camera 400 is not stored in the volatile memory 202, the control unit 201 returns the process to step S201.

In step S206, the control unit 201 reads out the identification information ID of each subject, which is the subject recognition result in step S202, from the volatile memory 202, and determines whether the tracking subject SUBJECT_ID exists in the sub-image of the sub-camera 400. Upon determining that the tracking subject SUBJECT_ID exists in the sub-image, the control unit 201 advances the process to step S207. Upon determining that the tracking subject SUBJECT_ID does not exist (disappears), the control unit 201 returns the process to step S201.

In step S207, the control unit 201 executes the function of the control information generation unit 223 shown in FIG. 3, and advances the process to step S208.

The control information generation unit 223 has a function of calculating the pan value/tilt value of the sub-camera 400. The control unit 201 reads out the coordinate information POSITION and the tracking subject SUBJECT_ID of the subject from the volatile memory 202, and specifies the position of the current tracking subject corresponding to the tracking subject SUBJECT_ID. The control unit 201 reads out the position of the tracking subject in the past in the image capture angle of view from the volatile memory 202, performs calculation such that the angular velocity of pan becomes large when the difference between the current position of the tracking subject and the position of the tracking subject in the past is large in the horizontal direction, and performs calculation such that the angular velocity of tilt becomes large when the difference is large in the vertical direction. The control unit 201 stores the pan value/tilt value in the volatile memory 202.

In step S208, the control unit 201 converts the pan value/tilt value read out from the volatile memory 202 into a control command in accordance with a predetermined protocol for controlling the sub-camera 400, stores it in the volatile memory 202, and advances the process to step S209.

In step S209, the control unit 201 transmits the control command according to the pan value/tilt value calculated in step S208 to the sub-camera 400 via the communication unit 205, and returns the process to step S201.

The basic operation of the EB 200 has been described above.

As described above, the WS 100 performs image recognition processing for the bird's-eye view image of the bird's-eye view camera 300, and when the tracking state information STATE indicates “tracking by the WS 100”, controls the pan operation/tilt operation of the sub-camera 400. When the tracking state information STATE indicates “tracking by the EB 200”, the pan operation/tilt operation of the sub-camera 400 is not controlled. The EB 200 performs image recognition processing for the sub-image of the sub-camera 400, and when the tracking subject is set and detected from the sub-image, controls the pan operation/tilt operation of the sub-camera 400. When the tracking subject is not set, the pan operation/tilt operation of the sub-camera 400 is not controlled.

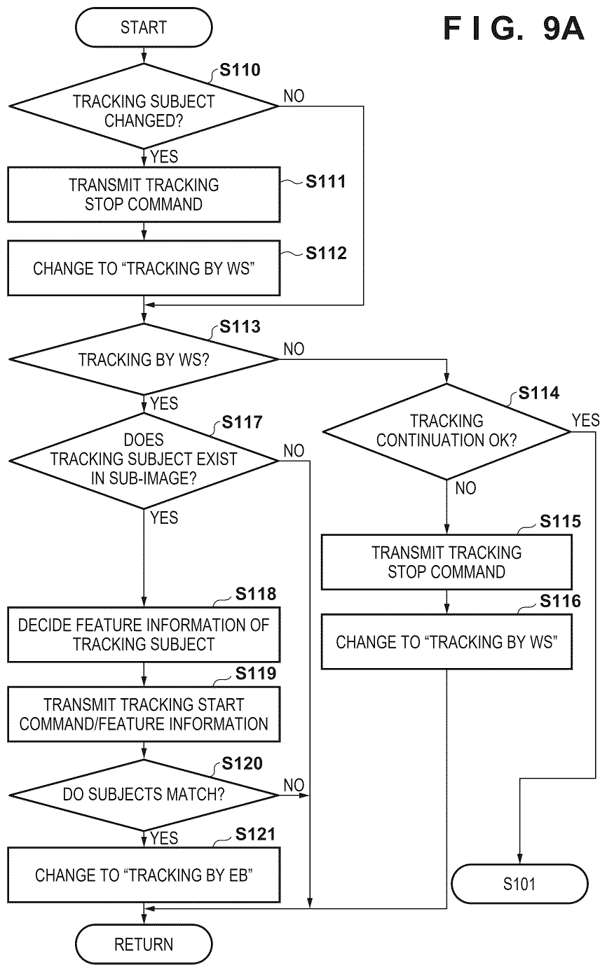

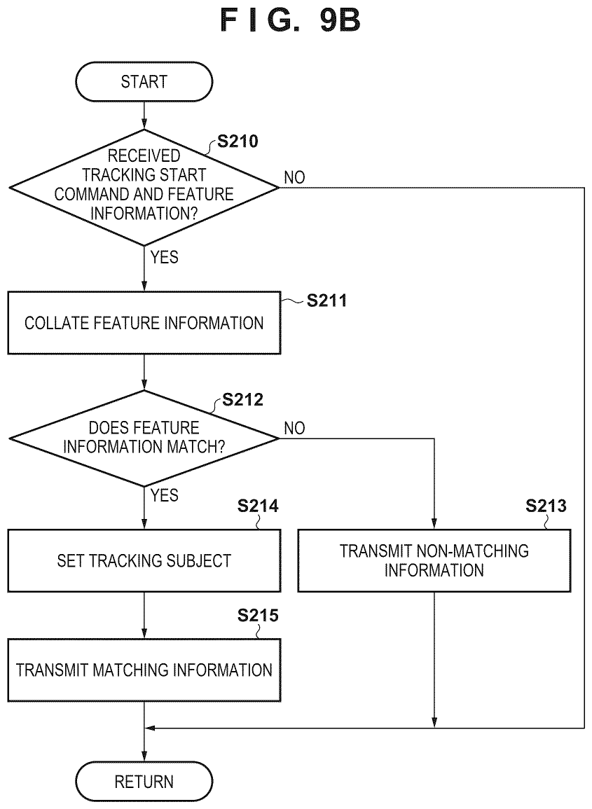

Also, the tracking state information STATE and the setting of the tracking subject are updated by control processing to be described later with reference to FIGS. 9A to 9C, thereby switching which one of the WS 100 and the EB 200 is to be used to control the sub-camera 400. Note that when the pan value/tilt value is transmitted by only one device controlling the sub-camera 400, and the pan value/tilt value is not transmitted during control by the other device, the communication amount can be decreased as compared to a case where the pan value/tilt value is transmitted for each of the processes shown in FIGS. 4A and 4B.

The operation of the bird's-eye view camera 300 upon receiving an image capture command from the WS 100 will be described next with reference to FIG. 4C.

In step S301, the control unit 301 receives an image capture command from the WS 100 via the communication unit 305, and advances the process to step S302.

In step S302, the control unit 301 starts image capture processing in accordance with reception of the image capture command by the communication unit 305, and advances the process to step S303. The control unit 301 captures an image by the image capture unit 306, and stores, in the volatile memory 302, image data generated by performing predetermined image processing by the image processing unit 307.

In step S303, the control unit 301 reads out the image data from the volatile memory 302 and transmits it to the WS 100 via the communication unit 305.

The operation of the bird's-eye view camera 300 has been described above.

The operation of the sub-camera 400 upon receiving a control command from the WS 100 or the EB 200 will be described next with reference to FIG. 4D.

In step S401, the control unit 401 receives a control command via the communication unit 405, stores the control command in the volatile memory 402, and advances the process to step S402.

In step S402, the control unit 401 reads out the pan value/tilt value from the volatile memory 402 in accordance with reception of the control command from the communication unit 405, and advances the process to step S403.

In step S403, the control unit 401 calculates driving parameters for controlling the pan operation/tilt operation at a desired speed in a desired direction based on the pan value/tilt value read out from the nonvolatile memory 403, and advances the process to step S404. The driving parameters are parameters for controlling actuators in the pan/tilt direction included in the PTZ driving unit 409, and the pan value/tilt value included in the control command is converted into the driving parameters by looking up a conversion table stored in the nonvolatile memory 403.

In step S404, the control unit 401 controls the optical unit 408 by the PTZ driving unit 409 based on the driving parameters obtained in step S403, thereby changing the image capture direction of the sub-camera 400. The PTZ driving unit 409 drives the optical unit 408 in the pan/tilt direction based on the driving parameters, thereby changing the image capture direction of the sub-camera 400.

The operation of the sub-camera 400 has been described above.

Control processing of the WS 100 will be described next with reference to FIG. 9A.

FIG. 9A shows control processing of the WS 100, and shows the detailed process of step S105 shown in FIG. 4A.

Apart of the processing shown in FIG. 9A is implemented by the control unit 101 executing the function of the tracking state decision unit 126 shown in FIG. 3.

The tracking state decision unit 126 has a function of updating the tracking state information STATE stored in the volatile memory 102.

In step S110, the control unit 101 reads out, from the volatile memory 102, the tracking subject SUBJECT_ID of the sub-camera 400 calculated in step S104 of FIG. 4A and the identification information ID indicating the tracking subject in the past. The control unit 101 then compares the identification information ID with the identification information read out from the volatile memory 102 and determines whether the tracking subject of the sub-camera 400 is changed. Upon determining that the tracking subject of the sub-camera 400 is changed, the control unit 101 advances the process to step S111. Upon determining that the tracking subject of the sub-camera 400 is not changed, the control unit 101 advances the process to step S113.

In step S111, the control unit 101 transmits a tracking stop command to the EB 200 via the communication unit 105, and advances the process to step S112.

In step S112, the control unit 101 executes the function of the tracking state decision unit 126 shown in FIG. 3, and changes the tracking state information STATE to “tracking by the WS 100”.

When the tracking subject of the sub-camera 400 is changed, the possibility that the tracking subject does not exist (disappears) in the image capture angle of view of the sub-camera 400 is high. In this case, the processes of steps S111 and S112 are performed, and the WS 100 controls the sub-camera 400 based on the bird's-eye view image of the bird's-eye view camera 300 in place of the sub-camera 400.

In step S113, the control unit 101 reads out the tracking state information STATE from the volatile memory 102, and determines, based on the tracking state information STATE, whether it indicates “tracking by the WS 100” or “tracking by the EB 200”. Upon determining that the tracking state information STATE indicates “tracking by the WS 100”, the control unit 101 advances the process to step S117. Upon determining that the tracking state information STATE indicates “tracking by the EB 200”, the control unit 101 advances the process to step S114.

In step S114, the control unit 101 transmits a tracking continuation confirmation request to the EB 200 via the communication unit 105, and inquires whether tracking of the tracking subject by the EB 200 can be continued. A response from the EB 200 is “tracking continuation OK” or “tracking continuation NG”. Upon receiving a notification of “tracking continuation OK” from the EB 200, the control unit 101 returns the process to step S101. Upon receiving a notification of “tracking continuation NG” from the EB 200, the control unit 101 advances the process to step S115.

In step S115, the control unit 101 transmits the tracking stop command to the EB 200 via the communication unit 105, and advances the process to step S116.

In step S116, the control unit 101 executes the function of the tracking state decision unit 126 shown in FIG. 3, updates the tracking state information STATE to “tracking by the WS 100”, and ends the processing.

By performing the processes of steps S114 to S116, even if the EB 200 cannot perform tracking any more in a case where the tracking state is “tracking by the EB 200”, tracking can be continued by the WS 100.

In step S117, the control unit 101 determines whether the tracking subject exists in the image capture angle of view of the sub-camera 400. Upon determining that the tracking subject exists in the image capture angle of view of the sub-camera 400, the control unit 101 advances the process to step S118. Upon determining that the tracking subject does not exist (disappears) in the image capture angle of view of the sub-camera 400, the control unit 101 ends the processing.

Whether the tracking subject exists in the image capture angle of view of the sub-camera 400 can be determined by comparing the current pan value/tilt value the control unit 101 obtained from the sub-camera 400 with the new pan value/tilt value calculated in step S107 of FIG. 4A.

When the current pan value/tilt value is sufficiently close to the new pan value/tilt value, it can be determined that the tracking subject exists in the image capture angle of view of the sub-camera 400. Alternatively, when the speed value of pan/tilt calculated in step S108 is sufficiently small, the current pan value/tilt value is close to the new pan value/tilt value, and therefore, it can be determined that the tracking subject exists in the image capture angle of view of the sub-camera 400.

In step S118, the control unit 101 executes the function of the feature information decision unit 125 shown in FIG. 3, and advances the process to step S119.

The feature information decision unit 125 has a function of deciding the feature information of the tracking subject of the sub-camera 400, that is, the feature information of the subject to be transmitted to the EB 200. The feature information decision unit 125 reads out, from the volatile memory 102, the feature information STAT[n] of the subject detected by the image recognition unit 121 from the bird's-eye view image of the bird's-eye view camera 300. Also, the feature information decision unit 125 reads out, from the volatile memory 102, the identification information SUBJECT_ID of the tracking subject decided by the tracking target decision unit 123. The feature information decision unit 125 decides feature information STAT[i] corresponding to the tracking subject among the pieces of feature information STAT[n], and stores it in the volatile memory 102. i is an index indicating the tracking subject.

In step S119, the control unit 101 transmits a tracking start command and the feature information STAT[i] of the tracking subject to the EB 200 via the communication unit 105, and advances the process to step S120.

By the processes of steps S117 to S119, only when the possibility that the tracking subject exists in the image capture angle of view of the sub-camera 400 is high, the tracking start command and the feature information of the tracking subject can be transmitted to the EB 200. Hence, the communication amount can be decreased as compared to a case where the information is transmitted for each of the processes shown in FIGS. 4A and 9A.

In step S120, the control unit 101 receives the collation result of the subjects from the EB 200 via the communication unit 105. Upon receiving, from the EB 200, matching information indicating that the subjects match, the control unit 101 advances the process to step S121. Upon receiving non-matching information indicating that the subjects do not match, the control unit 101 ends the processing.

In step S121, the control unit 101 executes the function of the tracking state decision unit 126 shown in FIG. 3, changes the tracking state information STATE to “tracking by the EB 200”, and ends the processing.

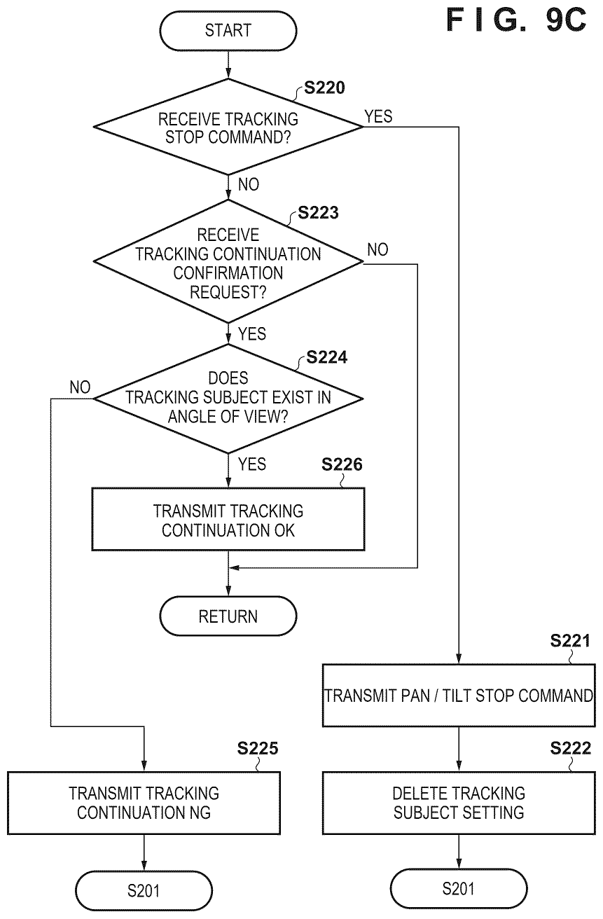

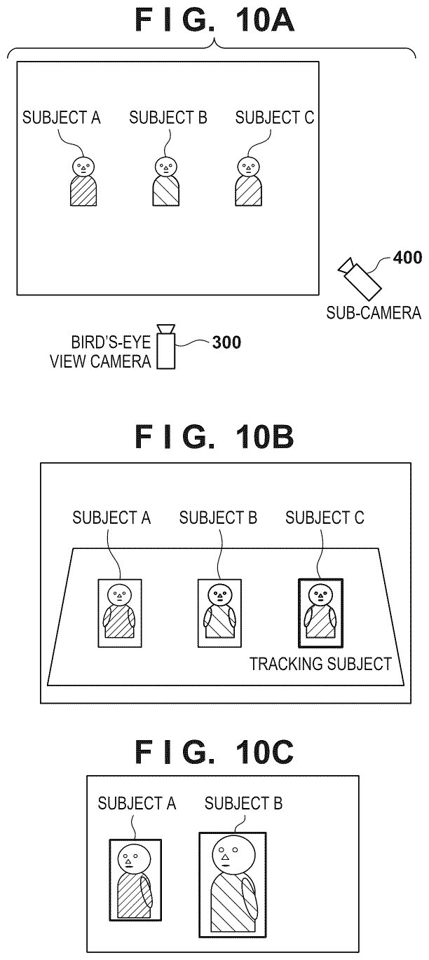

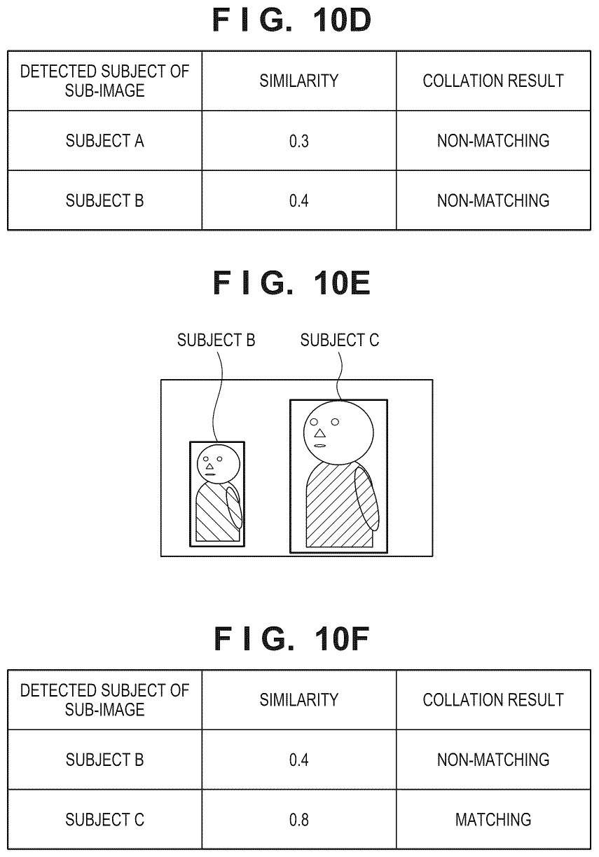

Control processing of the EB 200 will be described next with reference to FIGS. 9B, 9C, and 10A to 10F.

FIG. 9B shows control processing of the EB 200, and shows the detailed process of step S203 shown in FIG. 4B.

In step S210, the control unit 201 determines whether a tracking start command and the feature information STAT[i] of the tracking subject obtained from the bird's-eye view image of the bird's-eye view camera 300 are received from the WS 100 via the communication unit 205. When a tracking start command and the feature information STAT[i] of the tracking subject are received from the WS 100, the control unit 201 advances the process to step S211. When a tracking start command and the feature information STAT[i] of the tracking subject are not received, the control unit 201 ends the processing.

In steps S211 to S214, the control unit 201 executes the function of the tracking target decision unit 222 shown in FIG. 3, and determines whether the feature information STAT[i] received from the WS 100 and the feature information STAT_SUB[m] obtained from the sub-image of the sub-camera 400 satisfy a predetermined condition.

The tracking target decision unit 222 has a function of calculating a similarity from the feature information STAT[i] received from the WS 100 and the feature information STAT_SUB[m] obtained from the sub-image of the sub-camera 400. Also, the tracking target decision unit 222 has a function of comparing a threshold stored in the volatile memory 202 with the similarity of the feature information and storing the comparison result in the volatile memory 202.

For example, if two persons exist in the sub-image of the sub-camera 400, the tracking target decision unit 222 calculates the similarity between each of pieces of feature information (STAT_SUB[1] and STAT_SUB[2]) of the two persons and the feature information STAT[i] received from the WS 100. The similarity is calculated as the cosine similarity between feature information vectors, and a value of 0 to 1 is obtained as a similarity. The control unit 201 stores the similarities calculated for m subjects in the volatile memory 202.

In step S211, the control unit 201 executes the function of the tracking target decision unit 222 shown in FIG. 3, performs collation processing of feature information, and advances the process to step S212.

In step S212, the control unit 201 determines, in accordance with the collation result of step S211, whether there exist subjects having a high similarity between feature information. Existence of subjects having a high similarity between feature information means that the bird's-eye view camera 300 and the sub-camera 400 capture the same subject. Upon determining that there exist subjects having a high similarity between feature information, the control unit 201 advances the process to step S214. Upon determining that there do not exist subjects having a high similarity between feature information, the control unit 201 advances the process to step S213.

The control unit 201 reads out a predetermined threshold from the volatile memory 202. As a predetermined condition, when the similarity is equal to or larger than the threshold, or when there exists a subject with a higher similarity, or when subjects match, the control unit 201 determines that there exist subjects having a high similarity between feature information, and stores the identification information ID of the subject in the volatile memory 202.

In addition, the control unit 201 updates information MATCH representing whether there exist subjects having a high similarity between feature information, and stores it in the volatile memory 202. In the present embodiment, when the value of MATCH is 0, there do not exist subjects having a high similarity between feature information, that is, the subjects do not match between the bird's-eye view camera 300 and the sub-camera 400. When the value of MATCH is 1, there exist subjects having a high similarity between feature information, that is, the subjects match between the bird's-eye view camera 300 and the sub-camera 400.

When there exist subjects having a high similarity between feature information, the control unit 201 stores MATCH=1 in the volatile memory 202, and advances the process to step S214. When there do not exist subjects having a high similarity between feature information, the control unit 201 stores MATCH=0 in the volatile memory 202, and advances the process to step S213.

The similarity between the pieces of feature information of subjects detected from the bird's-eye view image of the bird's-eye view camera 300 and the sub-image of the sub-camera 400 will be described here with reference to FIGS. 10A to 10F.

FIG. 10A shows the positional relationship between the image capture position and the image capture direction of the bird's-eye view camera 300 and the image capture position and the image capture direction of the sub-camera 400. FIG. 10B shows subjects detected from the bird's-eye view image of the bird's-eye view camera 300 and a tracking subject.

Assume that the subject A, the subject B, and the subject C are detected from the bird's-eye view image of the bird's-eye view camera 300, and the tracking subject of the sub-camera 400 is the subject C. Feature information of the tracking subject of the sub-camera 400, which is transmitted from the sub-camera 400 to the WS 100, is information corresponding to the subject C. FIGS. 10C and 10E each show the sub-image of the sub-camera 400, and FIGS. 10D and 10F each show the similarity between the feature information of the tracking subject of the sub-camera 400 and the feature information of each subject detected from the sub-image.

As shown in FIG. 10C, when the sub-camera 400 is capturing the subject A and the subject B, the similarity between the feature information of the subject C in the bird's-eye view image of the bird's-eye view camera 300 and the feature information of the subject A or the subject B in the sub-image of the sub-camera 400 is calculated. As shown in FIG. 10D, the similarity between the feature information of the subject C in the bird's-eye view image of the bird's-eye view camera 300 and the feature information of the subject A or the subject B in the sub-image of the sub-camera 400 is low. In this case, for example, when the threshold of the similarity of a subject is 0.7, both the subject A and the subject B obtain a result of non-matching.

As shown in FIG. 10E, when the sub-camera 400 is capturing the subject B and the subject C, the similarity between the feature information of the subject C in the bird's-eye view image of the bird's-eye view camera 300 and the feature information of the subject B or the subject C in the sub-image of the sub-camera 400 is calculated. Since the image capture position and the image capture direction of the camera are different between the subject C in the bird's-eye view image of the bird's-eye view camera 300 and the subject C in the sub-image of the sub-camera 400, forms in the images are also different.

For example, when the subject C has its face or body facing the bird's-eye view camera 300, the subject C faces front in the bird's-eye view image of the bird's-eye view camera 300 but substantially turns sideways in the sub-image of the sub-camera 400. The inference model for subject specifying in each of the image recognition unit 121 of the WS 100 and the image recognition unit 221 of the EB 200 is a model that learns images obtained by capturing the same subject from a plurality of different directions. For this reason, when the same subject is captured by a plurality of cameras with different image capture positions or image capture directions, forms in the captured images are different, but the similarity between feature information is high.

That is, as shown in FIG. 10F, the similarity between the feature information of the subject C in the bird's-eye view image of the bird's-eye view camera 300 and the feature information of the subject C in the sub-image of the sub-camera 400 is high. Hence, when the threshold of the similarity of a subject is 0.7, the subject B obtains a result of non-matching, and the subject C obtains a result of matching. Hence, the subject C can be determined as the same subject.

Referring back to FIG. 9B, in step S213, the control unit 201 reads out MATCH=0 from the volatile memory 202, transmits it to the WS 100 via the communication unit 205, and ends the processing.

In step S214, the control unit 201 reads out the identification information ID of the subject for which the highest similarity is calculated from the volatile memory 202, stores it as the tracking subject SUBJECT_ID in the volatile memory 202, and advances the process to step S215. When the subject for which the highest similarity is calculated is selected, for example, even if subjects with similar clothing exist, the most likely subject among these can be obtained as the tracking target.

In step S215, the control unit 201 reads out MATCH=1 from the volatile memory 202, transmits it to the WS 100 via the communication unit 205, and ends the processing.

FIG. 9C shows control processing of the EB 200, and shows the detailed process of step S204 shown in FIG. 4B.

In step S220, the control unit 201 determines whether a tracking stop command is received from the WS 100 via the communication unit 205. When a tracking stop command is received from the WS 100, the control unit 201 advances the process to step S221. When a tracking stop command is not received, the control unit 201 advances the process to step S223.

In step S221, the control unit 201 transmits a control command for stopping the pan operation/tilt operation to the sub-camera 400 via the communication unit 305, and advances the process to step S222.

In step S222, the control unit 201 deletes the tracking subject SUBJECT_ID stored in the volatile memory 202, and returns the process to step S201.

In step S223, the control unit 201 determines whether a tracking continuation confirmation request is received from the WS 100 via the communication unit 205. When a tracking continuation confirmation request is received from the WS 100, the control unit 201 advances the process to step S224. When a tracking continuation confirmation request is not received, the control unit 201 ends the processing.

In step S224, the control unit 201 reads out the subject recognition result by the image recognition unit 221 from the volatile memory 202, and determines whether the tracking subject SUBJECT_ID is detected. Upon determining that the tracking subject SUBJECT_ID is detected by the image recognition unit 221, the control unit 201 advances the process to step S226. When the tracking subject SUBJECT_ID is not detected, the control unit 201 advances the process to step S225.

In step S225, the control unit 201 transmits “tracking continuation NG” to the WS 100 via the communication unit 205, and returns the process to step S201.

In step S226, the control unit 201 transmits “tracking continuation OK” to the WS 100 via the communication unit 205, and ends the processing.

Detailed control processing of the EB 200 has been described above.

According to the above-described first embodiment, the same subject can be recognized by the plurality of cameras 300 and 400 having different image capture positions or image capture directions. Hence, it is possible to track a specific subject while appropriately switching between control of the sub-camera 400 by the WS 100 and control of the sub-camera 400 by the EB 200.

When the tracking subject does not exist (disappears) in the sub-image of the sub-camera 400, control of the sub-camera 400 by the WS 100 is performed. When the tracking subject exists in the image capture angle of view of the sub-camera 400, control of the sub-camera 400 can be transferred from the WS 100 to the EB 200. Also, when the tracking subject moves at a high speed and is lost, or when changing the tracking subject, tracking can be continued by controlling the sub-camera 400 by the WS 100.

Note that in the first embodiment, an example in which whether to transmit the pan value/tilt value from the WS 100 or the EB 200 to the sub-camera 400 is switched has been described, but the present disclosure is not limited to this example. For example, regardless of the tracking state, the pan value/tilt value may be transmitted from the WS 100 and the EB 200 to the sub-camera 400, and from which device the sub-camera 400 receives the pan value/tilt value used to perform the pan operation/tilt operation may be controlled. In this case, in the processing of the WS 100, the process of step S106 in FIG. 4A is omitted, and processing of transmitting the tracking state information STATE from the control unit 101 to the sub-camera 400 is added before the process of step S107 in FIG. 4A. In the processing of the EB 200, the processes of steps S205 and S206 in FIG. 4B and the process of step S221 in FIG. 9C are omitted.

When the tracking state information STATE received from the WS 100 indicates “tracking by the EB 200”, the sub-camera 400 performs control to perform the pan operation/tilt operation in accordance with the control command received from the EB 200. When the tracking state information STATE received from the WS 100 indicates “tracking by the WS 100”, the sub-camera 400 performs control to perform the pan operation/tilt operation in accordance with the control command received from the WS 100.

Note that the edge box (EB) 200 may be configured integrally with the sub-camera 400, or alternatively, the functions of EB 200 may be incorporated within the sub-camera 400.

### Second Embodiment

In the first embodiment, an example in which the sub-camera 400 is controlled by one of the WS 100 and the EB 200 has been described. In the second embodiment, an example in which the EB 200 is omitted, and a WS 100 controls a sub-camera 400 based on the bird's-eye view image of a bird's-eye view camera 300 and the sub-image of the sub-camera 400 will be described.

In the second embodiment, the sub-camera 400 is controlled using one of a pan value/tilt value calculated based on the bird's-eye view image of the bird's-eye view camera 300 and a pan value/tilt value calculated based on the sub-image of the sub-camera 400.

The system configuration according to the second embodiment is obtained by omitting the EB 200 from the system configuration shown in FIG. 1, and the sub-image of the sub-camera 400 is input to the WS 100, unlike the first embodiment. Operations other than those of the WS 100 are the same as in the first embodiment.

As the basic operation, the bird's-eye view camera 300 transmits a bird's-eye view image to the WS 100. The sub-camera 400 transmits a sub-image to the WS 100. Also, the sub-camera 400 has a PTZ function.

The WS 100 detects a subject from the bird's-eye view image of the bird's-eye view camera 300 and the sub-image of the sub-camera 400, and changes the image capture direction of the sub-camera 400 to the direction of the tracking subject based on a subject recognition result. The WS 100 controls the sub-camera 400 based on the subject recognition result of the bird's-eye view image of the bird's-eye view camera 300 until the image capture direction of the sub-camera 400 changes to the direction of the tracking subject.

After the image capture direction of the sub-camera 400 changes to the direction of the tracking subject, the WS 100 calculates the feature information of the tracking subject from the bird's-eye view image of the bird's-eye view camera 300, and calculates the feature information of the subject from the sub-image of the sub-camera 400. Based on these pieces of feature information, the WS 100 controls the sub-camera 400. The feature information is information capable of specifying that the subject is the same subject in a case where the same subject is captured by a plurality of cameras having different image capture positions and/or image capture directions.

According to the second embodiment, it is possible to control the sub-camera 400 and track the tracking subject based on the subject recognition result of one of the bird's-eye view image of the bird's-eye view camera 300 and the sub-image of the sub-camera 400.

The hardware configurations of the WS 100, the bird's-eye view camera 300, and the sub-camera 400 are the same as in FIGS. 2A and 2B of the first embodiment.

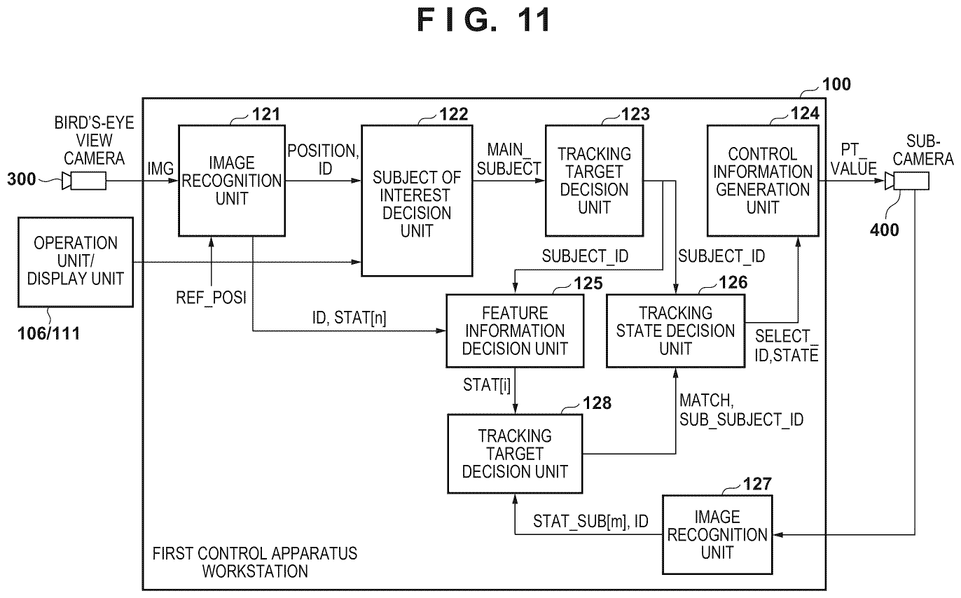

The functional configuration of the WS 100 configured to implement control processing according to the present embodiment will be described first with reference to FIG. 11.

The function of the WS 100 is implemented by hardware and/or software. Note that when the function units shown in FIG. 11 are not implemented by software but configured by hardware, a circuit configuration corresponding to each function unit shown in FIG. 11 is provided.

The WS 100 includes an image recognition unit 121, a subject of interest decision unit 122, a tracking target decision unit 123, a control information generation unit 124, a feature information decision unit 125, a tracking state decision unit 126, an image recognition unit 127, and a tracking target decision unit 128. The pieces of software configured to implement these functions are stored in a nonvolatile memory 103, and a control unit 101 loads these into a volatile memory 102 and executes them.

The functions of the image recognition unit 121, the subject of interest decision unit 122, the tracking target decision unit 123, and the feature information decision unit 125 are the same as in FIG. 3 of the first embodiment.

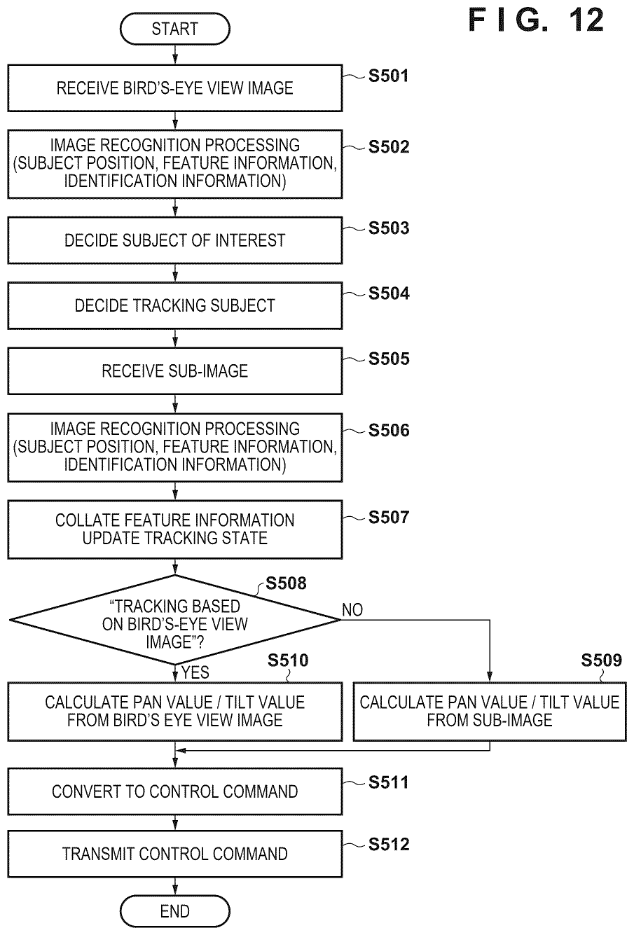

First, the functions and the basic operation of the WS 100 will be described with reference to FIGS. 11 and 12.

The processes of steps S501 to S504 are the same as the processes of steps S101 to S104 in FIG. 4A of the first embodiment.

In step S505, the control unit 101 transmits an image capture command to the sub-camera 400 via a communication unit 105, receives a captured sub-image from the sub-camera 400, stores it in the volatile memory 102, and advances the process to step S506.

In step S506, the control unit 101 executes the function of the image recognition unit 127 shown in FIG. 11, and advances the process to step S507.

As for the function of the image recognition unit 127, in the description of the image recognition unit 221 of the EB 200 according to the first embodiment, the control unit 201 is replaced with the control unit 101, the volatile memory 202 is replaced with the volatile memory 102, and the nonvolatile memory 203 is replaced with the nonvolatile memory 103.

In step S507, the control unit 101 executes the functions of the tracking target decision unit 128 and the tracking state decision unit 126 shown in FIG. 11, collates feature information calculated in steps S502 and S506, and updates tracking state information STATE. Also, the control unit 101 stores a tracking subject SUBJECT_ID and the tracking state information STATE in the volatile memory 102, and advances the process to step S508.

The tracking state information STATE includes information of one of “tracking based on the bird's-eye view image” and “tracking based on the sub-image”. “Tracking based on the bird's-eye view image” indicates a state in which the tracking subject is tracked by controlling the sub-camera 400 based on the subject recognition result of the bird's-eye view image of the bird's-eye view camera 300. “Tracking based on the sub-image” indicates a state in which the tracking subject is tracked by controlling the sub-camera 400 based on the subject recognition result of the sub-image of the sub-camera 400. Details of the process of step S507 will be described later.

The processes of steps S508 to S510 are executed by the function of the control information generation unit 124 shown in FIG. 11.

In step S508, the control unit 101 reads out the tracking state information STATE from the volatile memory 102, and determines, based on the tracking state information STATE, whether it indicates “tracking based on the bird's-eye view image” or “tracking based on the sub-image”. Upon determining that the tracking state information STATE indicates “tracking based on the bird's-eye view image”, the control unit 101 advances the process to step S510. Upon determining that the tracking state information STATE indicates “tracking based on the sub-image”, the control unit 101 advances the process to step S509.

In step S509, the control unit 101 calculates the pan value/tilt value of the sub-camera 400 based on the subject recognition result of the sub-image of the sub-camera 400, and advances the process to step S511. As for the process of step S509, in the processing of the control information generation unit 223 shown in FIG. 3, the control unit 201 is replaced with the control unit 101, and the volatile memory 202 is replaced with the volatile memory 102.

In step S510, the control unit 101 calculates the pan value/tilt value of the sub-camera 400 based on the subject recognition result of the bird's-eye view image of the bird's-eye view camera 300, and advances the process to step S511. As for the process of step S510, in the processing of the control information generation unit 223 shown in FIG. 3, the control unit 201 is replaced with the control unit 101, and the volatile memory 202 is replaced with the volatile memory 102.

In step S511, the control unit 101 executes the function of the control information generation unit 124 shown in FIG. 3, and advances the process to step S512.

The processes of steps S511 and S512 are the same as the processes of steps S108 and S109 in FIG. 4A.

The basic operation of the WS 100 has been described above.

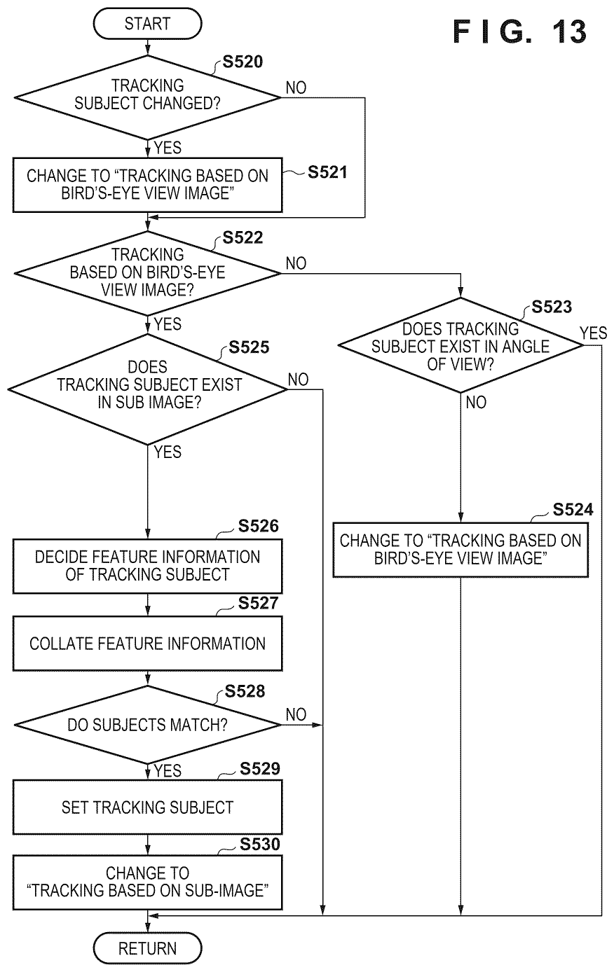

Control processing of the WS 100 will be described next with reference to FIG. 13.

FIG. 13 shows control processing of the WS 100, and shows the detailed process of step S507 shown in FIG. 12.

The process of step S520 is the same as the process of step S110 in FIG. 9A.

In step S521, the control unit 101 executes the function of the tracking state decision unit 126 shown in FIG. 11, and changes the tracking state information STATE to “tracking based on the image of the bird's-eye view camera”.

The tracking state decision unit 126 has a function of updating the tracking state information STATE stored in the volatile memory 102.

In step S522, the control unit 101 reads out the tracking state information STATE from the volatile memory 102, and determines, based on the tracking state information STATE, whether it indicates “tracking based on the bird's-eye view image” or “tracking based on the sub-image”. Upon determining that the tracking state information STATE indicates “tracking based on the bird's-eye view image”, the control unit 101 advances the process to step S525. Upon determining that the tracking state information STATE indicates “tracking based on the sub-image”, the control unit 101 advances the process to step S523.

As for the process of step S523, in the process of step S224 in FIG. 9B, the control unit 201 is replaced with the control unit 101, and the volatile memory 202 is replaced with the volatile memory 102.

In step S524, the control unit 101 executes the function of the tracking state decision unit 126 shown in FIG. 11, and changes the tracking state information STATE to “tracking based on the bird's-eye view image”.

The processes of steps S525 and S526 are the same as the processes of steps S117 and S118 in FIG. 9A.

As for the processes of steps S527 to S529, in the processes of steps S211 to S214 in FIG. 9B, the control unit 201 is replaced with the control unit 101, and the volatile memory 202 is replaced with the volatile memory 102.

In step S530, the control unit 101 executes the function of the tracking state decision unit 126 shown in FIG. 11, changes the tracking state information STATE to “tracking based on the sub-image”, and ends the processing.

According to the above-described second embodiment, the WS 100 switches which one of the subject recognition result of the bird's-eye view image of the bird's-eye view camera 300 and the subject recognition result of the sub-image of the sub-camera 400 is to be used to control the sub-camera 400. This can obviate the necessity of the EB 200 in the first embodiment, simplify the system configuration, and obtain the same effect as in the first embodiment.

### Third Embodiment

In the first and second embodiments, an example of a system including the bird's-eye view camera 300 and the sub-camera 400 has been described.

In the third embodiment, an example of a system including a main camera 500 in addition to a bird's-eye view camera 300 and a sub-camera 400 will be described.

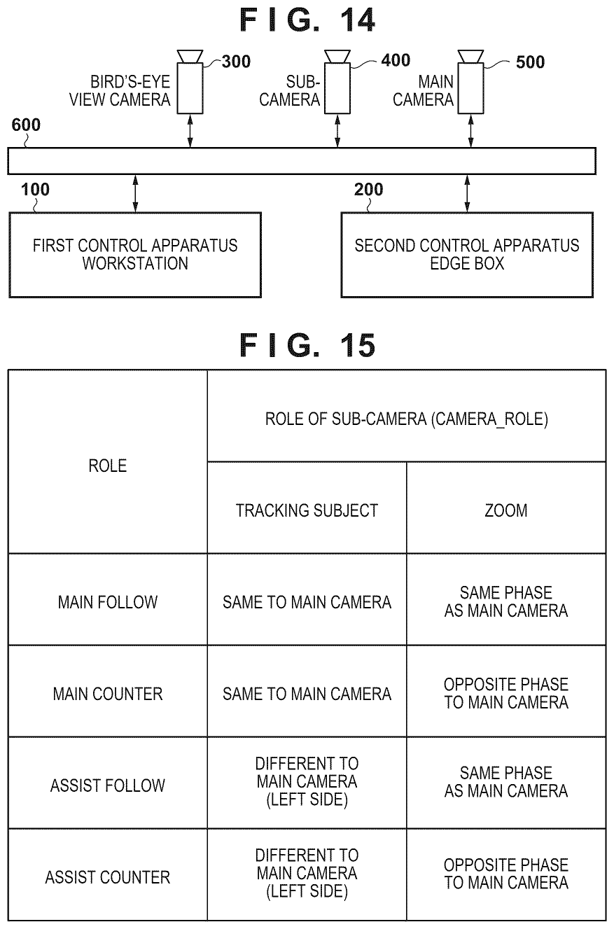

FIG. 14 is a view showing a system configuration according to the third embodiment.

The third embodiment is different from the first embodiment in that the system includes the main camera 500, and the tracking subject of the sub-camera 400 is decided based on a main image captured by the main camera 500. Differences from the first embodiment will mainly be described below.

In the third embodiment, the main camera 500 has a PTZ function. A subject of interest decision unit 122 of the WS 100 decides (estimates) the subject of interest of the main camera 500 from the image capture range of the main camera 500, and decides the tracking subject of the sub-camera 400 based on the subject of interest of the main camera 500. The tracking subject of the sub-camera 400 may be the same as the subject of interest of the main camera 500 or may be another subject.

An example in which the tracking subject of the sub-camera 400 is decided based on a role set in the sub-camera 400 will be described next.

The role of the sub-camera 400 indicates the control contents of the subject of interest of the main camera 500, the tracking subject of the sub-camera 400 associated with a zoom operation, and the zoom operation. The role of the sub-camera 400 can be set by a user via an operation unit provided on a WS 100 or an EB 200.

Also, when a plurality of sub-cameras are installed, one of the plurality of sub-cameras can be set to the main camera. The user may be allowed to set the main camera via the operation unit provided on the WS 100 or the EB 200. The role of the sub-camera 400 and the main camera setting method are not limited to the above-described methods, and any methods can be used.

FIG. 15 exemplarily shows roles and contents that can be set in the sub-camera 400.

When the role is “main follow”, the role (CAMERA_ROLE) of the sub-camera 400 is to track the same subject as the subject focused by the main camera 500 and perform zoom control in the same phase as the zoom operation of the main camera 500. Based on this role (CAMERA_ROLE), the zoom control value of the sub-camera 400 is calculated. Here, the same phase in the zoom operation means that the zoom operation of the main camera 500 and that of the sub-camera 400 are controlled in the same direction. For example, when the zoom control value of the main camera 500 is changed from the wide angle side to the telephoto side, the zoom of the sub-camera 400 is also changed from the wide angle side to the telephoto side.

When the role is “main counter”, the role (CAMERA_ROLE) of the sub-camera 400 is to track the same subject as the subject focused by the main camera 500 and perform zoom control in the phase opposite to the zoom operation of the main camera 500. Based on this role (CAMERA_ROLE), the PTZ value of the sub-camera 400 is calculated. Here, the opposite phase in the zoom operation means that the zoom operation of the main camera 500 and that of the sub-camera 400 are controlled in opposite directions. For example, when the zoom control value of the main camera 500 is changed from the wide angle side to the telephoto side, the zoom of the sub-camera 400 is changed from the telephoto side to the wide angle side.

When the role is “assist follow”, the sub-camera 400 tracks a subject different from the subject focused by the main camera 500 and performs zoom control in the same phase as the zoom operation of the main camera 500. Based on this role (CAMERA_ROLE), the zoom control value of the sub-camera 400 is calculated.

When the role is “assist counter”, the sub-camera 400 tracks a subject different from the subject focused by the main camera 500 and performs zoom control in the phase opposite to the zoom operation of the main camera 500. Based on this role (CAMERA_ROLE), the zoom control value of the sub-camera 400 is calculated. In the example shown in FIG. 15, “different from the main (left side)” is exemplified as the control contents of the tracking subject in “assist follow” and “assist counter”. However, there may be “assist follow” and “assist counter” in which the tracking subject is controlled to “different from the main (right side)”.

Also, in a case where the tracking subject is controlled to “different from the main”, there may be a role for controlling the subject to positions (upper/lower and front/rear sides) other than the left and right sides.

When a plurality of sub-cameras exist, a role may be set for each sub-camera.

In the third embodiment, an example in which the control contents of the tracking subject and zoom are set as the role has been described. However, the control contents of only the tracking subject may be set as a role, or another item may be added.

Also, in the third embodiment, an example in which the tracking subject of the sub-camera 400 is set based on the main image of the main camera 500, and the third embodiment is combined with the first embodiment has been described. However, the third embodiment may be combined with the second embodiment.

Furthermore, in a configuration that includes the bird's-eye view camera 300 and the sub-camera 400 as in the first and second embodiments, the sub-camera 400 may be controlled to track the target subject based on both the bird's-eye view image captured by the bird's-eye view camera and the sub-image captured by the sub-camera.

In addition, in a configuration that includes the bird's-eye view camera 300, the sub-camera 400, and the main camera 500 as in the third embodiment, the sub-camera 400 may be controlled to track the target subject based on any two or all of the bird's-eye view image, main image, and sub-image captured by the respective cameras.

According to the present disclosure, it is possible to track a specific subject using a plurality of image capture apparatuses having different image capture positions or image capture directions.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A system which includes a first image capture apparatus and a second image capture apparatus, which have different image capture directions, and a first control apparatus and a second control apparatus, which control the second image capture apparatus to track a predetermined subject based on a first image captured by the first image capture apparatus or a second image captured by the second image capture apparatus,
wherein
the first control apparatus comprises:
a first generation unit that generates first feature information of the predetermined subject included in the first image; and
a first control unit that controls the second image capture apparatus to track the predetermined subject based on the first feature information, and
the second control apparatus comprises:
a second generation unit that generates second feature information of a subject included in the second image;
a comparison unit that compares the first feature information generated by the first control apparatus with the second feature information generated by the second generation unit; and
a second control unit that controls the second image capture apparatus to track the predetermined subject based on the second feature information,
wherein the first feature information and the second feature information are information capable of specifying the same subject when the same subject is captured by a plurality of image capture apparatuses having different image capture directions, and
wherein based on a comparison result by the comparison unit, the system is configured to switch between a first state in which the first control apparatus controls the second image capture apparatus to track the predetermined subject based on the first feature information and a second state in which the second control apparatus controls the second image capture apparatus to track the predetermined subject based on the second feature information.

2. The system according to claim 1, wherein
The first control apparatus transmits the first feature information to the second control apparatus,
when the first feature information and the second feature information satisfy a predetermined condition based on the comparison result by the comparison unit, the first control unit switches to the second state, and
when the first feature information and the second feature information do not satisfy the predetermined condition, the first control unit switches to the first state.

3. The system according to claim 2, wherein
the predetermined condition is a case where a similarity between the first feature information and the second feature information is not less than a threshold, and
the comparison unit calculates the similarity between the first feature information and the second feature information and outputs a result of the comparison of the similarity and the threshold.

4. The system according to claim 1, wherein
when the predetermined subject exists in an image capture range of the second image capture apparatus, the second control unit controls the second image capture apparatus to track the predetermined subject,
when the predetermined subject disappears in the image capture range of the second image capture apparatus any more, the second control unit notifies the first control apparatus that tracking of the predetermined subject cannot be continued, and
the first control unit switches from the second state to the first state upon receiving the notification.

5. The system according to claim 1, wherein
when the predetermined subject is changed, the first control unit switches from the second state to the first state.

6. The system according to claim 5, wherein
when the predetermined subject is changed, the first control unit switches from the first state to the second state in a case where the first feature information and the second feature information satisfy a predetermined condition.

7. The system according to claim 1, wherein
the first control apparatus comprises:
a first tracking target decision unit configured to decide the predetermined subject from subjects detected in the first image;
a feature information decision unit configured to decide the first feature information of the predetermined subject and transmit the feature information to the second control apparatus; and
a first control information generation unit configured to generate first control information for controlling the image capture direction of the second image capture apparatus so as to track the predetermined subject; and
the second control apparatus comprises:
a second tracking target decision unit configured to decide the predetermined subject from subjects detected in the second image based on the second feature information of the subjects detected in the second image and the first feature information of the predetermined subject received from the first control apparatus; and
a second control information generation unit configured to generate second control information for controlling the image capture direction of the second image capture apparatus so as to track the predetermined subject.

8. The system according to claim 7, wherein
the second image capture apparatus controls the image capture direction of the second image capture apparatus so as to track the predetermined subject based on the control information obtained from the first control apparatus or the second control apparatus.

9. The system according to claim 7, wherein
the second image capture apparatus controls the image capture direction of the second image capture apparatus so as to track the predetermined subject based on one of the control information obtained from the first control apparatus and the second control apparatus.

10. The system according to claim 7, wherein
the control information includes at least one of a pan value and a tilt value.

11. The system according to claim 1, wherein
the first generation unit generates the first feature information by performing inference processing using a learned model with the first image as an input, and
the second generation unit generates the second feature information by performing inference processing using the learned model with the second image as an input and.

12. The system according to claim 11, wherein
the learned model includes a first model for subject detection and a second model for subject specifying,
the first generation unit generates first information indicating a position of the subject included in the first image by performing inference processing using the first model with the first image as an input, and
generates feature information of the subject included in the first image by performing inference processing using the second model with the first image and the first information as an input, and
the second generation unit generates second information indicating a position of the subject included in the second image by performing inference processing using the first model with the second image as an input, and
generates feature information of the subject included in the second image by performing inference processing using the second model with the second image and the second information as an input.

13. The system according to claim 12, wherein
the second model for subject specifying is a learned model that has learned using, as learning data, images obtained by capturing a plurality of subjects from a plurality of different image capture directions such that the similarity of feature information becomes high for images of the same subject.

14. A control apparatus which controls a second image capture apparatus to track a predetermined subject based on a first image captured by a first image capture apparatus or a second image captured by the second image capture apparatus which has a different image capture direction from the first image capture apparatus, comprising:
a generation unit that generates first feature information of the predetermined subject included in the first image; and
a control unit that controls the second image capture apparatus to track the predetermined subject,
wherein based on a comparison result in which an external apparatus compares the first feature information with second feature information of a subject included in the second image, the control unit switches between a first state in which the control apparatus controls the second image capture apparatus to track the predetermined subject based on the first feature information and a second state in which the external apparatus controls the second image capture apparatus to track the predetermined subject based on the second feature information, and
wherein the first feature information and the second feature information are information capable of specifying the same subject when the same subject is captured by a plurality of image capture apparatuses having different image capture directions.

15. A control apparatus which controls a second image capture apparatus to track a predetermined subject based on a second image captured by the second image capture apparatus which has a different image capture direction from a first image capture apparatus, comprising:
a generation unit that generates second feature information of a subject included in the second image;
a comparison unit that compares first feature information of the predetermined subject included in a first image captured by the first image capture apparatus obtained from an external apparatus with the second feature information; and
a control unit that controls the second image capture apparatus to track the predetermined subject based on the second feature information,
wherein the first feature information and the second feature information are information capable of specifying the same subject when the same subject is captured by a plurality of image capture apparatuses having different image capture directions, and
wherein when the first feature information and the second feature information satisfy a predetermined condition based on a comparison result by the comparison unit, the control unit controls the second image capture apparatus to track the predetermined subject based on the second feature information.

16. A control apparatus which controls a second image capture apparatus to track a predetermined subject based on a first image captured by a first image capture apparatus or a second image captured by the second image capture apparatus which has a different image capture direction from the first image capture apparatus, comprising:
a first generation unit that generates first feature information of the predetermined subject included in the first image;
a second generation unit that generates second feature information of a subject included in the second image; and
a control unit that controls the second image capture apparatus to track the predetermined subject,
wherein the first feature information and the second feature information are information capable of specifying the same subject when the same subject is captured by a plurality of image capture apparatuses having different image capture directions, and
wherein based on a result of comparing the first feature information with the second feature information, the control unit switches between a first state in which the control unit controls the second image capture apparatus to track the predetermined subject based on the first feature information and a second state in which the control unit controls the second image capture apparatus to track the predetermined subject based on the second feature information.

17. A control method of a control apparatus which controls a second image capture apparatus to track a predetermined subject based on a first image captured by a first image capture apparatus or a second image captured by the second image capture apparatus which has a different image capture direction from the first image capture apparatus, the method comprising:
generating first feature information of the predetermined subject included in the first image; and
controlling the second image capture apparatus to track the predetermined subject,
wherein based on a comparison result in which an external apparatus compares the first feature information with second feature information of a subject included in the second image, the controlling switches between a first state in which the control apparatus controls the second image capture apparatus to track the predetermined subject based on the first feature information and a second state in which the external apparatus controls the second image capture apparatus to track the predetermined subject based on the second feature information, and
wherein the first feature information and the second feature information are information capable of specifying the same subject when the same subject is captured by a plurality of image capture apparatuses having different image capture directions.

18. A control method of a control apparatus which controls a second image capture apparatus to track a predetermined subject based on a second image captured by the second image capture apparatus which has a different image capture direction from a first image capture apparatus, the method comprising:
generating second feature information of a subject included in the second image;
comparing first feature information of the predetermined subject included in a first image captured by the first image capture apparatus obtained from an external apparatus with the second feature information; and
controlling the second image capture apparatus to track the predetermined subject based on the second feature information,
wherein the first feature information and the second feature information are information capable of specifying the same subject when the same subject is captured by a plurality of image capture apparatuses having different image capture directions, and
wherein when the first feature information and the second feature information satisfy a predetermined condition based on a comparison result of the comparing, the controlling controls the second image capture apparatus to track the predetermined subject based on the second feature information.

19. A control method of a control apparatus which controls a second image capture apparatus to track a predetermined subject based on a first image captured by a first image capture apparatus or a second image captured by the second image capture apparatus which has a different image capture direction from the first image capture apparatus, the method comprising:
generating first feature information of the predetermined subject included in the first image;
generating second feature information of a subject included in the second image; and
controlling the second image capture apparatus to track the predetermined subject,
wherein the first feature information and the second feature information are information capable of specifying the same subject when the same subject is captured by a plurality of image capture apparatuses having different image capture directions, and
wherein based on a result of comparing the first feature information with the second feature information, the controlling switches between a first state in which the controlling controls the second image capture apparatus to track the predetermined subject based on the first feature information and a second state in which the controlling controls the second image capture apparatus to track the predetermined subject based on the second feature information.

20. A non-transitory computer-readable storage medium storing a program for causing a computer to function as a control apparatus which controls a second image capture apparatus to track a predetermined subject based on a first image captured by a first image capture apparatus or a second image captured by the second image capture apparatus which has a different image capture direction from the first image capture apparatus, comprising:
a generation unit that generates first feature information of the predetermined subject included in the first image; and
a control unit that controls the second image capture apparatus to track the predetermined subject,
wherein based on a comparison result in which an external apparatus compares the first feature information with second feature information of a subject included in the second image, the control unit switches between a first state in which the control apparatus controls the second image capture apparatus to track the predetermined subject based on the first feature information and a second state in which the external apparatus controls the second image capture apparatus to track the predetermined subject based on the second feature information, and
wherein the first feature information and the second feature information are information capable of specifying the same subject when the same subject is captured by a plurality of image capture apparatuses having different image capture directions.

21. A non-transitory computer-readable storage medium storing a program for causing a computer to function as a control apparatus which controls a second image capture apparatus to track a predetermined subject based on a second image captured by the second image capture apparatus which has a different image capture direction from a first image capture apparatus, comprising:
a generation unit that generates second feature information of a subject included in the second image;
a comparison unit that compares first feature information of the predetermined subject included in a first image captured by the first image capture apparatus obtained from an external apparatus with the second feature information; and
a control unit that controls the second image capture apparatus to track the predetermined subject based on the second feature information,
wherein the first feature information and the second feature information are information capable of specifying the same subject when the same subject is captured by a plurality of image capture apparatuses having different image capture directions, and
wherein when the first feature information and the second feature information satisfy a predetermined condition based on a comparison result by the comparison unit, the control unit controls the second image capture apparatus to track the predetermined subject based on the second feature information.

22. A non-transitory computer-readable storage medium storing a program for causing a computer to function as a control apparatus which controls a second image capture apparatus to track a predetermined subject based on a first image captured by a first image capture apparatus or a second image captured by the second image capture apparatus which has a different image capture direction from the first image capture apparatus, comprising:
a first generation unit that generates first feature information of the predetermined subject included in the first image;
a second generation unit that generates second feature information of a subject included in the second image; and
a control unit that controls the second image capture apparatus to track the predetermined subject,
wherein the first feature information and the second feature information are information capable of specifying the same subject when the same subject is captured by a plurality of image capture apparatuses having different image capture directions, and
wherein based on a result of comparing the first feature information with the second feature information, the control unit switches between a first state in which the control unit controls the second image capture apparatus to track the predetermined subject based on the first feature information and a second state in which the control unit controls the second image capture apparatus to track the predetermined subject based on the second feature information.
